(19) United States
(12) Patent Application Publication
(10) Pub. No.: US 2021/0260611 A1
(43) Pub. Date: Aug. 26, 2021

(54) METHOD FOR PRODUCING AN OPTIMIZED COATING, AND COATING WHICH CAN BE OBTAINED USING SAID METHOD

(71) Applicant: BASF Coatings GmbH, Muenster (DE)

(72) Inventors: Dirk Eierhoff, Muenster (DE); Daniel Briesenick, Muenster (DE); Georg Wigger, Muenster (DE); Christian Bornemann, Muenster (DE); Siegfried Riediger, Drensteinfurt (DE)

(21) Appl. No.: 17/252,990

(22) PCT Filed: Jun. 24, 2019
(86) PCT No.: PCT/EP2019/066695

§ 371 Date: Dec. 16, 2020

(30) Foreign Application Priority Data
Jun. 25, 2018 (EP) 18179586.5

(51) Int. Cl. B05B 12/08; C09D 133/08; C09D 175/02; C09D 175/04; B05D 1/02; B05D 7/00; G01N 15/02

(52) U.S. Cl. CPC B05B 12/082; C09D 133/08; C09D 175/02; G01N 2015/0026; B05D 1/02; B05D 7/576; G01N 15/0205; C09D 175/04

(57) ABSTRACT

Described herein is a method for producing at least one coating (B1) on a substrate, including provision of a coating material composition (BZ1) (1), determination of at least one characteristic variable of a drop size distribution within a spray formed on atomization of the coating material composition (BZ1), and/or of the homogeneity of this spray (2), reduction of the at least one characteristic variable and/or homogeneity of the spray (3), application of at least the coating material composition (BZ1) obtained after step (3), to a substrate, to form at least one film (F1) (4), and physical curing, chemical curing and/or radiation curing at least of the at least one film (F1) formed on the substrate by application of (BZ1), to produce the coating (B1) on the substrate. Also described herein is a coating (B1) located on a substrate and obtainable by means of this method.

The present invention relates to a method for producing at least one coating (B1) on a substrate, comprising at least the steps (1) to (5), specifically provision of a coating material composition (BZ1) (1), determination of at least one characteristic variable of the drop size distribution within a spray formed on atomization of the coating material composition (BZ1) provided as per step (1), and/or of the homogeneity of this spray (2), reduction of the at least one characteristic variable and/or homogeneity of the spray, determined as per step (2) (3), application of at least the coating material composition (BZ1) obtained after step (3), with reduced characteristic variable of the drop size distribution and/or reduced homogeneity, to a substrate, to form at least one film (F1) (4), and physical curing, chemical curing and/or radiation curing at least of the at least one film (F1) formed on the substrate by application of (BZ1) as per step (4), to produce the coating (B1) on the substrate, and also to a coating (B1) located on a substrate and obtainable by means of this method.

### BACKGROUND

Nowadays in the automobile industry in particular there are a range of coating material compositions, such as basecoat materials, that are applied by means of rotational atomization to the particular substrate that is to be coated. Such atomizers feature a fast-rotating application element such as a bell cup, for example, which atomizes the coating material composition to be applied, atomization taking place in particular by virtue of the acting centrifugal force, forming filaments, to produce a spray mist in the form of drops. The coating material composition is typically applied electrostatically, in order to maximize application efficiency and minimize overspray. At the edge of the bell cup, the coating material, atomized by means of centrifugal forces in particular, is typically charged by direct application of a high voltage to the coating material composition for application (direct charging). Following application of the respective coating material composition to the substrate, the resultant film—where appropriate following additional application of one or more other coating material compositions over it, in the form of one or further films—is cured or baked to give the resultant desired coating.

Optimization of coatings, especially coatings obtained in this way, with regard to particular desired properties of the coating, such as prevention or at least reduction in the tendency for development, or the incidence, of optical defects and/or surface defects such as, for example, pinholes, clouding, and/or in their appearance, is comparatively complicated and is typically only possible by empirical means. This means that such coating material compositions or, typically, entire test series thereof, within which different parameters have been varied, must first be produced and then, as described in the preceding paragraph, must be applied to a substrate and cured or baked. After that, the series of coatings then obtained must be investigated with regard to the desired properties, in order to allow any possible improvement in the properties investigated to be assessed. Typically, this procedure has to be multiply repeated with further variation of parameters, until the desired improvement in the property or properties of the coating investigated, after curing and/or baking, has been achieved.

It is known practice in the prior art to investigate and to characterize the coating material compositions used for producing such coatings on the basis of their shear viscosity behavior (shear rheology) to enable better understanding of their particular application characteristics. Here it is possible to make use, for example, of capillary rheometers. A disadvantage of this procedure, focused on investigation of the shear rheology, however, is that it fails to take account, or to take adequate account, of the quite significant influence of the extensional viscosity that occurs in the course of rotational atomization (extensional rheology). The extensional viscosity is a measure of the flow resistance of a material in an extensional flow. Such extensional flows occur typically, in addition to the shear flows, in all technical processes that are relevant in this regard, as in the case, for example, of capillary inlet and capillary outlet flows. In the case of a newtonian flow behavior, the extensional viscosity can be calculated from its constant ratio to the conventionally determined shear viscosity (Trouton ratio). In the case of a nonnewtonian flow behavior, which in practice, across a swathe of applications, occurs with far greater frequency, on the other hand, it is typically necessary for the extensional viscosity, as a parameter independent of the shear viscosity, to be determined experimentally with the aid of an extensional rheometer, for adequate consideration of the extensional rheology in the aforesaid description and characterization. Particularly when the aforesaid rotational atomization method is being carried out, the extensional viscosity may have a quite significant influence on the atomization process and on the breakdown of the filaments into drops which then form the spray mist. Techniques for determining the extensional viscosity are known in the prior art. It is typical here to determine the extensional viscosity by means of Capillary Breakup Extensional Rheometers (CaBERs). To date, however, there has been no available technique for giving adequate consideration equally to both extensional forces and shearing forces, without actually atomizing the material under investigation.

There is therefore a need for a method for producing coatings which makes it possible to obtain coatings having improved properties in respect of the prevention of or at least reduction in the tendency for formation and/or the incidence of optical defects and/or surface defects, without having to go through the whole coating and baking operation typically required in order to produce such coatings, and in particular without having to undertake comparatively costly and inconvenient investigation of the resultant coatings in respect of their desired properties, in order to be able to assess any possible improvement in the properties investigated. This is so even more since this procedure must normally be repeated a number of times until the desired improvement in the property or properties investigated for the coating has been achieved, this being disadvantageous from the standpoints both of economics and the environment.

### Problem

A problem addressed with the present invention, therefore, is that of providing a method for producing coatings that is advantageous both economically and environmentally and which makes it possible to obtain coatings having improved properties, especially in respect of the prevention or at least a reduction in the tendency for formation and/or the incidence of optical defects and/or surface defects. A particular problem addressed by the present invention is that of producing coatings which exhibit a lower, and in particular significantly lower, propensity to develop defects such as pinholes and/or which are notable for improved appearance. The coating material compositions used for producing these coatings are to have an extremely broad application window. A problem addressed by the present invention, in particular, is that of providing such a method for the use of aqueous basecoat materials as coating material compositions for producing basecoats, especially as part of a multicoat paint system.

### Solution

This problem is solved by the subject matter claimed in the claims and also by the preferred embodiments of this subject matter that are described in the description hereinafter.

A first subject of the present invention is therefore a method for producing at least one coating (B1) on a substrate, comprising at least the steps (1) to (5), specifically
(1) provision of a coating material composition (BZ1),
(2) determination of at least one characteristic variable of the drop size distribution within a spray formed on atomization of the coating material composition (BZ1) provided as per step (1), and/or of the homogeneity of this spray,
   wherein the homogeneity of the spray corresponds to the ratio of two quotients T_{T1}/T_{Total1} and T_{T2}/T_{Total2} to one another as a measure of the local distribution of transparent and nontransparent drops at two different positions within the spray, with T_{T1} corresponding to the number of transparent drops at the first position 1, T_{T2} corresponding to the number of transparent drops at the second position 2, T_{Total1} corresponding to the number of all drops of the spray and hence to the sum total of transparent drops and nontransparent drops at position 1, and T_{Total2} corresponding to the number of all drops of the spray and hence to the sum total of transparent drops and nontransparent drops at position 2, with position 1 being nearer to the center of the spray than position 2,
(3) reduction of the at least one characteristic variable of the drop size distribution and/or homogeneity of the spray formed on atomization of the coating material composition (BZ1), determined as per step (2),
(4) application of at least the coating material composition (BZ1) obtained after step (3), with reduced characteristic variable of the drop size distribution and/or reduced homogeneity, to a substrate, to form at least one film (F1), and
(5) physical curing, chemical curing and/or radiation curing at least of the at least one film (F1) formed on the substrate by application of the coating material composition (BZ1) as per step (4), to produce the coating (B1) on the substrate.

A further subject of the present invention is a coating (B1) which is located on a substrate and which is obtainable by the method of the invention, i.e., according to the first subject of the present invention.

The determination of the drop size distribution of the drops formed by the atomization as per step (2) entails the determination of at least one characteristic variable known to the skilled person, such as suitable average diameters of the drops, such as, in particular, the D₁₀ (arithmetic diameter; “1,0” moment), D₃₀ (volume-equivalent average diameter; “3,0” moment), D₃₂ (Sauter diameter (SMD); “3,2” moment), d_{N,50}% (number-based median) and/or d_{V,50}% (volume-based median). The determination of the drop size distribution here encompasses the determination of at least one such characteristic variable, more particularly a determination of the D₁₀ of the drops. The aforesaid characteristic variables are in each case the corresponding numerical mean of the drop size distribution. The moments of the distributions are labeled here using the upper-case letter “D”; the index specifies the corresponding moment. The characteristic variables labeled with the lower-case letter “d” here are the percentiles (10%, 50%, 90%) of the corresponding cumulative distribution curve, with the 50% percentile corresponding to the median. The index “N” pertains to the number-based distribution, the index “V” to the volume-based distribution.

The reduction of at least one characteristic variable of the drop size distribution of the drops formed by the atomization as per step (2), and/or of the homogeneity, within step (3) is to be understood in accordance with the invention as a reducing of the respective ascertained value of the characteristic variable such as the D₁₀ and/or of the ascertained value of the homogeneity (that is, the ratio of the quotients T_{T1}/T_{Total1} and T_{T2}/T_{Total2} to one another).

It has surprisingly been found that the method of the invention makes it possible to produce coatings having improved properties, especially in respect of the prevention of or at least a reduction in the tendency for formation, and/or the incidence, of optical defects and/or surface defects. It has more particularly been found here that by means of the method of the invention, it is possible to produce coatings which exhibit a smaller, and in particular significantly smaller, tendency to develop defects such as pinholes and/or which are distinguished by an improved appearance. This is so in particular when the coating material compositions (BZ1) used within the method of the invention are basecoat materials such as aqueous basecoat materials, by means of which basecoats can be produced, especially as part of a multicoat paint system.

It has surprisingly been found, moreover, that the method of the invention enables a more economical and more environmental regime by comparison with conventional methods, since coatings without, or at least with fewer, optical defects and/or surface defects can be obtained, this being possible, nevertheless, without the need to go through the entire coating and baking operation typically necessary in order to produce such coatings, and the optimization of their aforesaid advantageous properties, and in particular without the need for the resultant coatings to be analyzed, at comparatively great cost and inconvenience, for their desired properties, in order to be able to assess any possible improvement in the properties investigated. This is especially advantageous from an economic and environmental standpoint since this procedure within conventional methods must otherwise typically be repeated a number of times until the desired improvement in the investigated property or properties of the coating has been achieved. In this respect, therefore, the method of the invention is less costly and inconvenient and has, in particular, (time-)economic and financial advantages over corresponding conventional methods.

It has in particular been surprisingly found that the aforesaid advantages in relation to the prevention of or at least a reduction in the tendency for formation and/or the incidence of optical defects and/or surface defects can be realized technically by implementation of step (3) in the method of the invention, in other words by reducing the at least one characteristic variable of the drop size distribution and/or homogeneity, ascertained as per step (2), of the spray formed on atomization of the coating material composition (BZ1) provided as per step (1), with the determination of this or these characteristic variable(s) and/or of the homogeneity taking place within step (2). By means of the method of the invention it is possible surprisingly, on the basis of this or these ascertained characteristic variable(s) and/or of the ascertained homogeneity, for a coating material composition (BZ1), to achieve a reduction in this or these characteristic variable(s) and/or in the homogeneity and so to reduce at least the incidence of optical defects and/or surface defects on the part of the coating to be produced. Serving as a comparison here is a coating produced by means of the same method but without implementation of step (3). It has surprisingly been found that the characteristic variable(s) of the drop size distribution and/or of the homogeneity of the spray correlate with the incidence of the aforesaid optical defects and/or surface defects, and/or with their prevention/reduction. The smaller the respective characteristic variable of the drop size distribution and/or the homogeneity, the lower the incidence of defects. It is made possible accordingly, depending on the characteristic variables of the drop size distribution and/or the homogeneity that occur in the atomization, to be able to control the resulting properties such as optical properties and/or surface properties of the coating to be produced, and in particular to prevent or at least reduce the incidence of optical defects and/or surface defects. By means of the method of the invention, in other words, on the basis of the investigation of the atomization behavior of a coating material composition (BZ1), determination of the characteristic variable(s) stated in step (2) and/or of the homogeneity, and reduction of this or these characteristic variable(s) and/or of the homogeneity in step (3), it is possible to improve the properties of the final coating, especially with respect to optimization in the incidence of pinholes, of cloudiness, of streakiness, the leveling, and/or the appearance. It has surprisingly been found, in particular, that this or these ascertained characteristic variable(s) and/or the ascertained homogeneity correlate with these properties better than other techniques known from the prior art, such as CaBER measurements.

It has further been found that as a result in particular of the determination of the characteristic variable(s) and/or the homogeneity stated in step (2) the influence of the extensional viscosity that occurs on atomization of coating material compositions which can be employed for producing coatings, such as the coating material composition (BZ1), is adequately considered. This is so in particular because, with this determination can be comparatively high extension rates considered, namely extension rates of up to 100 000 s⁻¹, and hence extension rates higher than those in the case of conventional CaBER measurements for determining the extensional viscosity, for which, especially in the case of basecoat materials, only extension rates of up to 1000 s⁻¹ are achieved, and the determination of the characteristic variable(s) stated in step (2) and/or of the homogeneity therefore takes place at aforesaid comparatively high extension rates. As a result of the fact that the method of the invention, with step (2), itself includes the implementation of an atomization, it is possible to give consideration both to shear rheology and to extensional rheology within a single method, sufficiently, and not using techniques which are able to capture only individual elements (shear rheology or extensional rheology).

As mentioned above, it has further surprisingly been found that by means of the method of the invention, particularly in the case of aqueous basecoat materials which are used as coating material compositions (BZ1) in the atomization, conclusions can be drawn from the particle size distributions determined for the drops, i.e., the drop size distribution ascertained, particularly on the basis of determinations of the D₁₀ values as a characteristic variable of the drops, and/or of the homogeneity of the spray, about the appearance of the coating to be produced. Smaller drop sizes denote a “finer” atomization of the coating material composition used. Maximally fine atomization is desirable since it entails a lower wetness, in other words a less wet appearance to the film formed after application of the coating material composition used. The skilled person is aware that too great a wetness can lead to unwanted incidence of pops and/or pinholes, to a poorer shade and/or flop, and/or to the occurrence of clouding. Equally, corresponding conclusions can be drawn on the basis of the quotient T_{T}/T_{Total}, as a measure of the local distribution of transparent and nontransparent drops and hence as a measure of the homogeneity of the spray mist formed in the atomization. T_{T} is the number of transparent drops and T_{Total} the number of all the drops and hence the sum total of transparent drops and nontransparent drops. In a spray mist formed in an atomization such as a rotational atomization, the fraction of nontransparent drops, in other words, for example, the fraction of drops containing (effect) pigment, increases from inside to outside because of the centrifugal force. If there is a comparatively sharp change in the ratio of the quotient T_{T1}/T_{Total1} to the quotient T_{T2}/T_{Total2} within the spray mist, with increasing distance from the edge of the bell (if a rotational atomizer is used in step (2)), this means that there is a significant change in the composition of the spray mist from inside to outside. Via the determination of the ratio of the quotient T_{T1}/T_{Total1} to the quotient T_{T2}/T_{Total2}, or on the basis of the determination as to how sharply this ratio changes from inside to outside, it is therefore possible to state whether a material used is more strongly separated, on application, into regions with different concentrations of (effect) pigments, with increasing values of the aforesaid ratio, and is therefore less homogeneous or more susceptible to the formation of surface defects such as streaks, than another material.

### DETAILED DESCRIPTION

### Method for Producing a Coating (B1) on a Substrate

The method of the invention for producing at least one coating (B1) on a substrate comprises at least the steps (1) to (5).

The coating (B1) is preferably part of a multicoat paint system on the substrate. The coating (B1) preferably represents a basecoat of a multicoat paint system on the substrate. The substrate used is preferably a precoated substrate.

By means of the method of the invention, at least the coating (B1) is applied at least partly to a substrate, and preferably at least one surface of the substrate is covered, preferably completely.

The method of the invention comprises at least the steps (1) to (5), but may optionally also include further steps. Steps (1) to (5) are preferably carried out in numerical order. Within step (2), preferably, steps (2a) and (2b), which are described in more detail below, are carried out synchronously; that is, the optical capture as per step (2b) takes place preferably during the implementation of step (2a).

Optionally and preferably, within the method of the invention, it is possible for one or more further coating material compositions to be applied to the substrate, these compositions each preferably being different from the composition (BZ1) and from one another. Particularly if the composition (BZ1) represents a preferably aqueous basecoat material, it is possible after implementation of step (4) (in the case of wet-on-wet application) or after implementation of step (5) for at least one further coating material composition to be applied, such as, for example, a clearcoat material, such as a solventborne clearcoat. The clearcoat material may be a commercial clearcoat, which in turn is applied by commonplace techniques, the film thicknesses again being situated within the commonplace ranges, as for example 5 to 100 micrometers.

The method of the invention preferably comprises at least one further step (4a), which is carried out before implementation of step (5) but after implementation of step (4). Step (4a) provides for the application, before implementation of step (5), of at least one further coating material composition (BZ2), different from the coating material composition (BZ1), to the film (F1) obtained as per step (4), to produce a film (F2), and for the resultant films (F1) and (F2) to be subjected jointly to step (5). The coating material composition (BZ2) is preferably a clearcoat material, more preferably a solventborne clearcoat material.

Following the application of the clearcoat material, it can be flashed off at room temperature (23° C.) for 1 to 60 minutes, for example, and optionally dried. The clearcoat is then cured, preferably together with the applied coating material composition (BZ1), within step (5). Here, for example, crosslinking reactions take place, producing an effect-imparting and/or color- and effect-imparting multicoat paint system on a substrate.

Within the method of the invention, preference is given to using metallic substrates. Also possible in principle, however, are nonmetallic substrates, especially plastics substrates. The substrates used may have been coated. If a metal substrate is to be coated, it is preferably coated with an electrocoat prior to the application of a surfacer and/or primer-surfacer and/or of a basecoat material. If a plastics substrate is being coated, it is preferably further pretreated prior to the application of a surfacer and/or primer-surfacer and/or of a basecoat material. The methods most commonly employed for such pretreatment are flaming, plasma treatment, and corona discharge. Flaming is used with preference. The coating material composition (BZ1) used is preferably, as mentioned above, a basecoat material, more particularly a waterborne basecoat material. Accordingly, the coating (B1) obtained is preferably a basecoat. In this case, prior to application of the basecoat material, it is optionally possible for the substrate to contain at least one of the aforementioned coatings, i.e., a surfacer and/or primer-surfacer and/or electrocoat layer. In this case, the substrate employed preferably has an alectrocoat layer (ETL), more preferably an electrocoat layer applied by means of cathodic deposition of an electrocoat.

### Step (1)

Step (1) of the method of the invention envisages the provision of a coating material composition (BZ1).

### Step (2)

In step (2) of the method of the invention, at least one characteristic variable of the drop size distribution within a spray formed on atomization of the coating material composition (BZ1) provided as per step (1), and/or the homogeneity of this spray, is determined, wherein the homogeneity of the spray corresponds to the ratio of two quotients T_{T1}/T_{Total1} and T_{T2}/T_{Total2} to one another as a measure of the local distribution of transparent and nontransparent drops at two different positions within the spray, with T_{T1} corresponding to the number of transparent drops at the first position 1, T_{T2} corresponding to the number of transparent drops at the second position 2, T_{Total1} corresponding to the number of all drops of the spray and hence to the sum total of transparent drops and nontransparent drops at position 1, and T_{Total2} corresponding to the number of all drops of the spray and hence to the sum total of transparent drops and nontransparent drops at position 2, with position 1 being nearer to the center of the spray than position 2.

The atomization is carried out preferably by means of a rotational atomizer or a pneumatic atomizer.

The concept of “rotational atomizing” or of “high-speed rotational atomizing” is one which is known to the skilled person. Such rotational atomizers feature a rotating application element that atomizes the coating material composition to be applied into a spray mist in the form of drops, owing to the acting centrifugal force. The application element in this case is a preferably metallic bell cup.

In the course of rotational atomization by means of atomizers, so-called filaments develop first, at the edge of the bell cup, and then go on, in the further course of the atomization process, to break down further into aforesaid drops, which then form a spray mist. The filaments therefore constitute a precursor of these drops. The filaments may be described and characterized by their filament length (also referred to as “thread length”) and their diameter (also referred to as “thread diameter”).

The concept of “pneumatic atomization” and pneumatic atomizers used for this purpose are likewise known to the skilled person.

When step (2) is carried out, sufficient consideration is given to the extensional viscosity which occurs during the atomization. The skilled person is aware of the concept of extensional viscosity, with the unit Pascal-seconds (Pa·s), as a measure of the flow resistance of a material in an extensional flow. Techniques for determining the extensional viscosity are likewise known to the skilled person. The extensional viscosity is typically determined using what are called Capillary Breakup Extensional Rheometers (CaBERs), which are sold by Thermo Scientific, for example.

The average characteristic variable stated in step (2) or the homogeneity is preferably determined by means of implementation of at least the following method steps (2a), (2b), and (2c), specifically by means of

(2a) atomization of the coating material composition (BZ1), provided as per step (1), by means of an atomizer, the atomization producing a spray,
(2b) optical capture of the drops of the spray formed by atomization as per step (2a), by a traversing optical measurement through the entire spray, and
(2c) determination of at least one characteristic variable of the drop size distribution within the spray and/or of the homogeneity of the spray, on the basis of optical data obtained by the optical capture as per step (2b).

### Step (2a)

Step (2a) of the method of the invention relates to the atomization of the coating material composition (BZ1) by means of an atomizer, with the atomization producing a spray. The atomizer is preferably, as mentioned above, a rotational atomizer or a pneumatic atomizer. Where a rotational atomizer is used, it preferably has as its application element a bell cup which is capable of rotation. Here, optionally, the atomized coating material composition (BZ1) may undergo electrostatic charging at the edge of the bell cup by the application of a voltage.

Where a rotational atomizer is used in step (2a), the speed of rotation (rotational velocity) of the bell cup is adjustable. In the present case the rotation speed is preferably at least 10 000 revolutions/min (rpm) and at most 70 000 revolutions/min. The rotational velocity is preferably in a range from 15 000 to 70 000 rpm, more preferably in a range from 17 000 to 70 000 rpm, more particularly from 18 000 to 65 000 rpm or from 18 000 to 60 000 rpm. At a rotation speed of 15 000 revolutions per minute or above, a rotational atomizer of this kind, in the sense of this invention, is referred to preferably as a high-speed rotational atomizer. Rotational atomization in general and high-speed rotational atomization in particular are widespread within the automobile industry. The (high-speed) rotational atomizers used for these processes are available commercially; examples include products of the Ecobell® series from the company Durr. Such atomizers are suitable preferably for electrostatic application of a multiplicity of different coating material compositions, such as paints, that are used in the automobile industry. Particularly preferred for use as coating material compositions within the method of the invention are basecoat materials, more particularly aqueous basecoat materials. The coating material composition may be applied electrostatically, but need not be. In the case of electrostatic application, there is electrostatic charging of the coating material composition, atomized by centrifugal forces, at the bell cup edge, by preferably direct application of a voltage such as a high voltage to the coating material composition that is to be applied (direct charging).

The discharge rate of the coating material composition to be atomized, during the implementation of step (2a), is adjustable. The discharge rate of the coating material composition for atomization, during the implementation of step (2a), is preferably in a range from 50 to 1000 mL/min, more preferably in a range from 100 to 800 mL/min, very preferably in a range from 150 to 600 mL/min, more particularly in a range from 200 to 550 mL/min.

The discharge rate of the coating material composition for atomization, during the implementation of step (2a), is preferably in a range from 100 to 1000 mL/min or from 200 to 550 mL/min, and the rotary speed of the bell cup in the case of rotational atomization is preferably in a range from 15 000 to 70 000 revolutions/min or from 15 000 to 60 000 rpm.

The coating material composition used in step (2a) of the method of the invention is preferably a basecoat material, more preferably an aqueous basecoat material, more particularly an aqueous basecoat material which comprises at least one effect pigment.

### Step (2b)

Step (2b) sees the drops of the spray formed by an atomization as per step (2a) being captured optically by a traversing optical measurement through the entire spray.

The implementation of this traversing measurement allows the entire spray, and hence the entire drop spectrum forming the spray, to be captured in its entirety. As a result, the capture of all of the drop sizes forming the spray is made possible. The entire spray can be measured in its entirety (and not just individual regions of the spray). The traversing measurement allows locationally resolved—i.e., point-specific—optical measurement of the drops at numerous locations in the atomization spray, and so determination in the subsequent step (2c) is made more precise than if the measurement did not take place traversingly. The implementation of the traversing measurement takes place preferably by moving the atomizing head of the atomizer used during the implementation of step (2b). Alternatively, however, a relative movement of the measuring system is likewise possible.

The traversing optical measurement as per step (2b) may be carried out at different traversing speeds. This speed may be linear or nonlinear. Through the choice of the traversing speed it is possible to simplify the area weighting: for instance, an increase in the traversing speed with increase of the area segments fulfils this purpose, and so the product of area and residence time is constant. The traversing speed is preferably selected such as to obtain at least 10 000 counts per area segment of the spray. The term “counts” in this context refers to the number of drops detected in the measurement within the spray or within different area segments of the spray. The area segments represent positions within the spray.

The optical capture as per step (2b) of the method of the invention is accomplished preferably by means of an optical measurement which is based on scattered light investigations on the drops contained within the spray, and is carried out on these drops. This measurement is preferably accomplished using at least one laser.

The optical capture as per step (2b) of the method of the invention takes place preferably by means of phase Doppler anemometry (PDA) and/or by means of the time-shift technique (TS). From the optical data obtained when carrying out step (2b) by means of PDA, it is possible in step (2c) to determine at least one characteristic variable of the drop size distribution. From the optical data obtained when carrying out step (2b) by means of TS, it is possible in step (2c) to determine both at least one characteristic variable of the drop size distribution and the homogeneity of the spray.

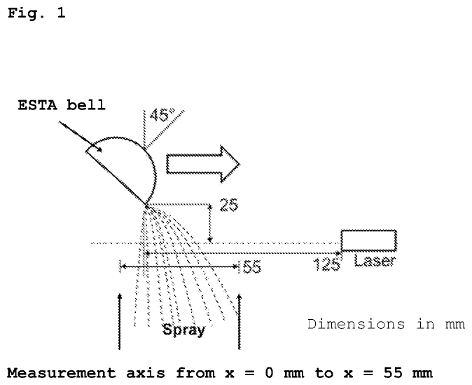

The optical measurement takes place preferably on a measurement axis which is traversed repeatedly, as depicted in FIG. 1, for example. The repetition is preferably 1 to 5 times, and more preferably it takes place at least 5 times. With particular preference the measurement takes place with at least 10 000 counts per measurement and/or at least 10 000 counts per area segment within the spray. Duplicated measurement of the individual events is prevented preferably by an evaluation facility contained within the system. According to FIG. 1, as an example, a rotational atomizer is used.

Step (2b) may be carried out at different tilt angles of the atomizer relative to the measuring facility carrying out the measurement as per step (2b). Accordingly it is possible to vary the tilt angle from 0 to 90°. In FIG. 1 this angle, by way of example, is 45°.

The optical capture as per step (2b) takes place preferably with a detector.

### Use of PDA in Step (2b)

The procedure for determining the drop size distribution may take place by means of

Phase Doppler Anemometry (PDA). This technique is known fundamentally to the skilled person, from, for example, F. Onofri et al., Part. Part. Sys. Charact. 1996, 13, pages 112-124 and A. Tratnig et al., J. Food. Engin. 2009, 95, pages 126-134. The PDA technique is a measurement method based on the formation of an interference plane pattern in the intersection volume of two coherent laser beams. The particles moving in a flow, such as, for example, the drops of the atomization spray mist that are investigated in accordance with the present invention, scatter light, when passing through the intersection volume of the laser beams, with a frequency referred to as the Doppler frequency, which is directly proportional to the velocity at the location of the measurement. From the difference in phase position of the scattered light signal at preferably at least two detectors used, these detectors being sited at different locations in the space, it is possible to determine the radius of curvature of the particle surface. In the case of spherical particles, this leads to the particle diameter; in the case of drops, therefore, it leads to the respective drop diameter. For high measurement accuracy it is advantageous to design the measuring system, particularly in relation to the scattering angle, in such a way that a single scattering mechanism (reflection or first-order refraction) is dominant. The scattered light signal is typically converted by photomultipliers into electronic signals, which are evaluated, using covariance processors or by means of an FFT analysis (Fast Fourier Transformation analysis), for the Doppler frequency and the difference in the phase positions. The use of a Bragg cell here makes it possible, preferably, to carry out controlled manipulation of the wavelength of one of the two laser beams, and so to generate an ongoing interference plane pattern.

PDA systems measure the phase shifts (that is, the difference in the phase positions) customary in received light signals by using different receiving apertures (masks).

Within step (2b) of the method of the invention, in the case of implementation by means of PDA, a mask is preferably employed that can be used to detect drops having a maximum possible drop diameter of 518.8 μm.

Corresponding instruments suitable for implementing the PDA method are available commercially, an example being the Single-PDA from DantecDynamics (P60, Lexel argon laser, FibreFlow).

During implementation of step (2b), the PDA is operated preferably in forward scattering at an angle of 60-70° with a wavelength of 514.5 nm (polarized orthogonally) in reflection. The receiving optics in this case preferably have a focal length of 500 mm; the transmitting optics preferably have a focal length of 400 mm.

The optical measurement according to step (2b) by means of PDA takes place traversingly in a radial-axial direction in relation to the tilted atomizer used, preferably at a 45° tilt angle. In principle, however, as mentioned above, tilt angles in a range from 0 to 90°, preferably >0 to <90°, such as from 10 to 80°, are possible. The optical measurement takes place preferably 25 mm vertically below the flank of the atomizer that is inclined to the traversing axis. Measurements have shown the process of drop formation to be concluded at this position. One such setup is shown, by way of example, in FIG. 1. In this case, a defined traversing speed is preferably mandated, so that locational resolution of the individual events detected takes place via the associated time-resolved signals. A comparison with raster-resolved measurements yields identical results for the weighted global characteristic distribution values, but also allows the investigation of any desired interval ranges on the traversing axis. This technique, moreover, is more rapid by a multiply factor than rastering, thereby allowing the physical expenditure to be reduced at constant flow rates.

### Use of TS in Step (2b)

Alternatively or additionally to the PDA technology, the drop size distribution may be determined using the time-shift technique. The time-shift technique (TS) is likewise fundamentally known to the skilled person, from, for example, an article by W. Schafer et al., ICLASS 2015, 13th Triennial International Conference on Liquid Atomization and Spray Systems, Tainan, Taiwan, pages 1 to 7, and an article by M. Kuhnhenn et al., ILASS Europe 2016, 27th Annual Conference on Liquid Atomization and Spray Systems, 4-7 Sep. 2016, Brighton UK, pages 1 to 8, and also from W. Schafer et al., Particuology 2016, 29, pages 80-85.

The time-shift technique (TS) is a measurement method which is based on the backscattering of light (e.g., laser light) by particles such as, in the case of the present invention, by the drops of the spray mist resulting from the atomization. The TS technique is based on the light scattering of an individual particle from a shaped light beam such as a laser beam. The scattered light of the individual particle is interpreted as the sum total of all orders of scattering present at the location of the detector used. In approximation to the geometric optics, this corresponds to an analysis of the propagation of individual light beams through the particle, with a varying number of internal reflections. The laser beam used for implementing the time-shift technique is typically focused by lenses. The light which has been scattered by the particles is divided into perpendicularly polarized and parallel-polarized light, and is captured separately by preferably at least two photodetectors. The signal coming from the detectors in turn supplies the necessary information for ascertaining a determination of the drop size distribution and/or homogeneity. The wavelength of the light of the illuminating beam used is in the same order of magnitude as or smaller than that of the particles to be measured. The laser beam ought therefore to be selected so that it does not exceed the size of the drops, in order to give the time-shift signal. If this value is exceeded, the signal is no longer a suitable basis for the determination of the size referred to above. Otherwise the problem arises that the signal components of the different scatterings overlap and can therefore not be captured and distinguished individually. The time-shift technique can be used for determining characteristic properties of the particles, such as for determining the drop size distribution. Moreover, the time-shift technique (TS) allows differentiation between bubbles, i.e., transparent drops (T), and solids-containing particles, i.e., nontransparent drops (NT). Corresponding instruments suitable for these purposes are available commercially, examples being instruments from the SpraySpy® series from AOM Systems. The implementation of traversing measurements by means of instruments from the SpraySpy® series, while being fundamentally known, is nevertheless only utilized in the prior art in order to determine the width of the spray jet, but not in order to determine the homogeneity of the spray and/or characteristic variables of the drop size distribution.

The optical measurement according to step (2b) by means of TS takes place traversingly in a radial-axial direction in relation to the tilted atomizer used, preferably at a 45° tilt angle. In principle, however, as mentioned above, tilt angles in a range from 0 to 90°, preferably >0 to <90°, such as from 10 to 80°, are possible. The optical measurement takes place preferably 25 mm vertically below the flank of the atomizer that is inclined to the traversing axis. Measurements have shown the process of drop formation to be concluded at this position. One such setup is shown, by way of example, in FIG. 1. In this case, a defined traversing speed is preferably mandated, so that locational resolution of the individual events detected takes place via the associated time-resolved signals. A comparison with raster-resolved measurements yields identical results for the weighted global characteristic distribution values, but also allows the investigation of any desired interval ranges on the traversing axis. This technique, moreover, is more rapid by a multiply factor than rastering, thereby allowing the physical expenditure to be reduced at constant flow rates.

### Step (2c)

Step (2c) of the method of the invention envisions the determination of at least one characteristic variable of the drop size distribution within the spray and/or of the homogeneity of the spray on the basis of optical data obtained by virtue of the optical capture as per step (2b).

As already mentioned above, the determination of the drop size distribution of the drops formed by the atomization as per step (2a), in accordance with the invention, preferably entails the determination of corresponding characteristic variables known to the skilled person, such as the D₁₀ (arithmetic diameter; “1,0” moment), D₃₀ (volume-equivalent average diameter; “3,0” moment), D₃₂ (Sauter diameter (SMD); “3,2” moment), d_{N,50}% (number-based median) and/or d_{V,50}% (volume-based median), with at least one of these characteristic variables of the drop size distribution being determined within step (2c). In particular, the determination of the drop size distribution encompasses a determination of the D₁₀ of the drops. This is done in particular if step (2b) is carried out by means of PDA and/or TS.

If step (2b) is carried out by means of PDA, the optical data obtained after implementation of step (2b) are preferably evaluated via an algorithm for any desired tolerances within step (2c). A tolerance of around 10% for the PDA system used limits the validation to spherical drops; an increase also brings slightly deformed drops into the assessment. As a result, it becomes possible to assess the sphericity of the measured drops along the measurement axis.

If step (2b) is carried out by means of TS, the optical data obtained after implementation of step (2b) are preferably likewise evaluated via an algorithm for any desired tolerances.

The homogeneity of the spray refers to the ratio of the two quotients T_{T1}/T_{Total1} and T_{T2}/T_{Total2} to one another, as a measure of the local distribution of transparent and nontransparent drops at two different positions within the spray, with T_{T1} corresponding to the number of transparent drops at the first position 1, T_{T2} to the number of transparent drops at the second position 2, T_{Total1} to the number of all the drops in the spray, and hence to the sum total of transparent drops and nontransparent drops, at position 1, and T_{Total2} to the number of all the drops in the spray, and hence to the sum total of transparent drops and nontransparent drops, at position 2, with position 1 being nearer to the center of the spray than position 2. The homogeneity may be determined in particular if TS is used when carrying out step (2b).

Position 1, which is closer to the center of the spray than position 2, preferably represents an area segment within the spray that is different from position 2. Position 1—being located closer to the center of the spray than position 2—is located further in the interior of the spray than position 2, which, correspondingly, is located further outward in the spray, and at any rate further outward than position 1. If the spray is imagined in the form of a cone, position 1 is located further in the cone interior than position 2. Both positions, 1 and 2, preferably lie on a measurement axis which leads through the entire spray. This is depicted by way of example in FIG. 1. The distance between the two positions 1 and 2 within the spray, based on the overall length of the part of the measurement axis that is located within the spray and that corresponds to a figure of 100%, is preferably at least 10%, more preferably at least 15%, very preferably at least 20%, and more particularly at least 25% of this length of the measurement axis.

The data thus obtained by means of TS as per implementation of step (2b) can therefore be evaluated for the transparent spectrum (T) and for the nontransparent spectrum (NT) of the drops. The ratio of the number of measured drops in both spectra serves as a measure of the local distribution of transparent and nontransparent drops. An integral assessment along the measurement axis is possible. Specifically, the ratio of the transparent drops (T) to the total number of drops (Total) is determined preferably at a position of x=5 mm or x=25 mm along the measurement axis. These positions then correspond to the aforesaid positions 1 (x=5 mm) and 2 (x=25 mm). A ratio is formed in turn from the corresponding values, in order to describe the spray jet (spray) homogeneity, which changes from the inside outward.

### Step (3)

In step (3) of the method of the invention, at least one characteristic variable of the drop size distribution and/or homogeneity of the spray formed on atomization of the coating material composition (BZ1), as determined in accordance with step (2), is reduced.

The reduction in accordance with step (3) is accomplished preferably by adaptation of at least one parameter within the formula of the coating material composition (BZ1) provided in accordance with step (1).

This adaptation of at least one parameter within the formula of the coating material composition (BZ1) preferably comprises at least one adaptation selected from the group of adaptations of the following parameters:
(i) raising or lowering the amount of at least one polymer present as binder component (a) in the coating material composition (BZ1),
(ii) at least partially replacing at least one polymer present as binder component (a) in the coating material composition (BZ1) by at least one polymer different thereto,
(iii) raising or lowering the amount of at least one pigment and/or filler present as component (b) in the coating material composition (BZ1),
(iv) at least partially replacing at least one filler present as component (b) in the coating material composition (BZ1) by at least one filler different thereto, and/or at least partially replacing at least one pigment present as component (b) in the coating material composition (BZ1) by at least one pigment different thereto,
(v) raising or lowering the amount of at least one organic solvent present as component (c) in the coating material composition (BZ1), and/or of water present therein,
(vi) at least partially replacing at least one organic solvent present as component (c) in the coating material composition (BZ1) by at least one organic solvent different thereto,
(vii) raising or lowering the amount of at least one additive present as component (d) in the coating material composition (BZ1),
(viii) at least partially replacing at least one additive present as component (d) in the coating material composition (BZ1) by at least one additive different thereto, and/or adding at least one further additive different thereto,
(ix) changing the sequence of the addition of the components used for preparing the coating material composition (BZ1), and/or
(x) raising or lowering the energy input of the mixing when preparing the coating material composition (BZ1).

By means of parameter (v) it is possible in particular to raise or lower the spray viscosity of the coating material composition (BZ1). Parameters (vii) and/or (viii) comprise in particular the replacement and/or the addition of thickeners as additives, and, respectively, the changing of their amount in (BZ1). Such thickeners are described in more detail below in the context of component (d). Parameters (i) and/or (ii) comprise in particular the replacement and/or the addition of binders, or the changing of their amount, in (BZ1). The concept of the binder is elucidated in more detail hereinafter. It also embraces crosslinkers (crosslinking agents). Accordingly, the parameters (i) and/or (ii) also comprise a change in the relative weight ratio of crosslinker and of that binder constituent which enters into a crosslinking reaction with the crosslinker. Parameters (i) to (iv) comprise in particular the replacement and/or the addition of binders and/or pigments, or the changing of their amount, in (BZ1). Accordingly, these parameters (i) to (iv) implicitly also embrace a change in the pigment/binder ratio within (BZ1).

The adaptation of at least one parameter within the formula of the coating material composition (BZ1) more preferably comprises at least one adaptation selected from the group of adaptations of the following parameters:
(iii) raising or lowering, in particular raising, the amount of at least one pigment and/or filler, in particular effect pigment, present as component (b) in the coating material composition (BZ1),
(iv) at least partially replacing at least one filler present as component (b) in the coating material composition (BZ1) by at least one filler different thereto, and/or at least partially replacing at least one pigment present as component (b) in the coating material composition (BZ1) by at least one pigment different thereto, in particular at least partially replacing at least one pigment present as component (b) in the coating material composition (BZ1) by at least one pigment different thereto, the pigment in each case preferably being an effect pigment,
(v) raising or lowering the amount of at least one organic solvent present as component (c) in the coating material composition (BZ1), and/or of water present therein, preferably raising the amount of water present therein as component (c) in the coating material composition (BZ1) and/or preferably reducing the amount of at least
   one organic solvent present as component (c) in the coating material composition (BZ1),
(vii) raising or lowering the amount of at least one additive present as component (d) in the coating material composition (BZ1), and/or
(viii) at least partially replacing at least one additive present as component (d) in the coating material composition (BZ1) by at least one additive different thereto, and/or adding at least one further additive different thereto.

The adaptation of at least one parameter within the formula of the coating material composition (BZ1) very preferably comprises at least one adaptation selected from the group of adaptations of the following parameters:
(iii) raising or lowering, in particular raising, the amount of at least one pigment and/or filler, in particular effect pigment, present as component (b) in the coating material composition (BZ1),
(iv) at least partially replacing at least one filler present as component (b) in the coating material composition (BZ1) by at least one filler different thereto, and/or at least partially replacing at least one pigment present as component (b) in the coating material composition (BZ1) by at least one pigment different thereto, in particular at least partially replacing at least one pigment present as component (b) in the coating material composition (BZ1) by at least one pigment different thereto, the pigment in each case preferably being an effect pigment, and/or
(v) raising or lowering the amount of at least one organic solvent present as component (c) in the coating material composition (BZ1), and/or of water present therein, preferably raising the amount of water present therein as component (c) in the coating material composition (BZ1) and/or preferably lowering the amount of
   at least one organic solvent present as component (c) in the coating material composition (BZ1).

The raising or lowering of the amount of at least one pigment or pigments present as component (b) in the coating material composition (BZ1), as per (iii), is preferably accomplished such that the pigment content resulting from the raising or lowering differs by at most ±10% by weight, more preferably at most ±5% by weight, from the pigment content of the coating material composition (BZ1) before this parameter adaptation (iii) is carried out.

The at least partial replacement of at least one pigment present as component (b) in the coating material composition (BZ1), as per parameter adaptation (iv), takes place preferably such that the at least one pigment present in (BZ1) before the parameter adaptation (iv) is at least partially replaced only by at least one pigment that is substantially identical to it.

The term “substantially identical pigment” is understood in the sense of the present invention in connection with effect pigments to mean that the effect pigment or pigments amenable to being at least partially replaced, as a first condition, have an identical chemical composition to an extent of at least 80% by weight, preferably at least 85% by weight, more preferably at least 90% by weight, very preferably at least 95% by weight, more particularly at least 97.5% by weight, based in each case on their total weight, but preferably in each case to an extent of less than 100% by weight, to the effect pigment or pigments in the coating material composition (BZ1). Effect pigments are substantially identical, for example, if they are in each case aluminum effect pigments but have a different coating—for example, in one case a chromation and in the other case a silicate coat, or in one case being coated and in the other case not. A further, additional condition for “substantially identical pigments” in the sense of the present invention in connection with effect pigments is that the effect pigments differ from one another in their average particle size by at most ±20%, preferably at most ±15%, more preferably at most ±10%. The average particle size is the arithmetic numerical mean of the measured average particle diameter (d_{N,50%}; number-based median) as determined by laser diffraction in accordance with ISO 13320 (date: 2009). The concept of the effect pigment per se is elucidated further and in more detail hereinafter.

The term “substantially identical pigment” in the sense of the present invention in connection with color pigments is understood to mean that the color pigment or pigments amenable to being at least partially replaced, as a first condition, differ from one another in their chromaticity by at most ±20%, preferably at most ±15%, more preferably at most ±10%, more particularly at most ±5%, from color pigment(s) present in the coating material composition (BZ1), before the parameter adaptation (iv).

The chromaticity here denotes the

a,b chromaticity CIE 1976 (CIELAB chromaticity): c*_{ab}=[(a*)²+(b*)²]^{1/2}

and is determined according to DIN EN ISO 11664-4 (date: June 2012). A further, additional condition of “substantially identical pigments” in the sense of the present invention in connection with color pigments is that the color pigments differ from one another in their average particle size by at most ±20%, preferably at most ±15%, more preferably at most ±10%. The average particle size is the arithmetic numerical mean of the measured average particle diameter (d_{N,50}%) as determined by laser diffraction in accordance with ISO 13320 (date: 2009). The concept of the color pigment per se is elucidated further and in more detail hereinafter.

### Step (4)

Step (1) of the method of the invention provides for application of at least the coating material composition (BZ1) obtained after step (3), with reduced characteristic variable of the drop size distribution and/or reduced homogeneity, to a substrate, to form at least one film (F1).

The application in step (4), especially if (BZ1) is a basecoat material, may take place at the film thicknesses customary within the automobile industry, in the range from, for example, 5 to 100 micrometers, preferably 5 to 60 micrometers, especially preferably 5 to 30 micrometers, most preferably from 5 to 20 micrometers.

Application as per step (4) takes place preferably by means of atomization such as pneumatic atomization or rotational atomization, especially by rotational atomization of the coating material composition (BZ1) obtained after step (3).

The embodiments referred to hereby and described in connection with step (2a) are valid equally, presently, for step (4) if step (4) takes place by means of rotational atomization. The concept of “pneumatic atomization” and pneumatic atomizers used for this purpose are likewise known to the skilled person.

As already mentioned above, the method of the invention comprises at least one further step (4a), which is carried out before implementation of step (5) but after implementation of step (4). Step (4a) provides for the application, prior to implementation of step (5), of at least one further coating material composition (BZ2), different from the coating material composition (BZ1), to the film (F1) obtained as per step (4), to produce a film (F2), and the subjection of the resulting films (F1) and (F2) in unison to step (5). The coating material composition (BZ2) is preferably a clearcoat material, more preferably a solventborne clearcoat material. After the clearcoat material has been applied, it may be flashed off at room temperature (23° C.) for 1 to 60 minutes, for example, and optionally dried. The clearcoat is then preferably cured together with the applied coating material composition (BZ1) within step (5).

### Step (5)

In step (5) of the method of the invention, a physical curing, chemical curing and/or radiation curing is carried out on at least the at least one film (F1), formed by application of the coating material composition (BZ1) to the substrate as per step (4), to produce the coating (B1) on the substrate.

The concept of physical curing here embraces preferably a thermal cure, i.e., the baking of the at least one film (F1) applied as per step (4). The baking is preferably preceded by drying by known techniques. For example, (1-component) basecoat materials, which are preferred, can be flashed off at room temperature (23° C.) for 1 to 60 minutes and subsequently cured preferably at possibly slightly elevated temperatures of 30 to 90° C. Flashing off and drying in the context of the present invention refer to the evaporation of organic solvents and/or water, making the paint drier but not yet curing it, or not yet forming a fully crosslinked coating film. Curing, in other words baking, is accomplished preferably thermally at temperatures from 30 to 200° C. such as from 60 to 150° C. The coating of plastics substrates is basically similar to that of metal substrates. Here, however, curing generally takes place at much lower temperatures, of 30 to 90° C.

The chemical curing is accomplished preferably by means of crosslinking reactions of suitable crosslinkable functional groups, which are preferably parts of the polymer used as binder (a). Any customary crosslinkable functional group known to the skilled person is contemplated here. In particular, the crosslinkable functional groups are selected from the group consisting of hydroxyl groups, amino groups, carboxylic acid groups, isocyanates, polyisocyanates, and epoxides. Chemical curing takes place preferably in combination with physical curing.

Examples of suitable radiation sources for the radiation cure are low-pressure, medium-pressure, and high-pressure mercury lamps, and also fluorescent tubes, pulsed radiant emitters, metal halide radiant emitters (halogen lamps), lasers, LEDs, and, moreover, electronic flash installations, enabling radiation curing without photoinitiator, or excimer emitters. The radiation cure is accomplished by exposure to high-energy radiation, i.e., UV radiation, or daylight, or by bombardment with high-energy electrons. The radiation dose normally sufficient for crosslinking in the case of UV curing is in the range from 80 to 3000 mJ/cm². It is also of course possible to use a plurality of radiation sources for curing, such as two to four, for example. These sources may also emit each in different wavelength ranges.

Coating Material Composition Used in Accordance with the Invention

The embodiments below pertain not only to the method of the invention but also to the coating (B1) of the invention, which is described in more detail below. The embodiments that are described below pertain in particular to the coating material composition (BZ1) that is used.

The coating material composition used in accordance with the invention preferably comprises
at least one polymer employable as binder, as component (a),
at least one pigment and/or at least one filler as component (b), and
water and/or at least one organic solvent as component (c).

The term “comprising” or “embracing” in the sense of the present invention, especially in connection with the coating material composition used in accordance with the invention, preferably has the meaning of “consisting of”. With regard to the coating material composition used in accordance with the invention, for example, it may comprise not only components (a), (b), and (c) but also one or more of the other, optional components identified hereinafter such as component (d). All these components may each be present in their preferred embodiments as stated below.

The coating material composition used in accordance with the invention is preferably a coating material composition which is employable in the automobile industry. Here it is possible to use coating material compositions which can be employed as part of an OEM paint system, and those which can be employed as part of a refinish system. Examples of coating material compositions employable in the automobile industry are electrocoat materials, primers, surfacers, basecoat materials, especially waterborne basecoat materials (aqueous basecoat materials), topcoat materials, including clearcoat materials, especially solventborne clearcoat materials. The use of waterborne basecoat materials is particularly preferred.

The concept of the basecoat material is known to the skilled person and defined for example in Römpp Lexikon, Lacke and Druckfarben, Georg Thieme Verlag, 1998, 10^{th} edition, page 57. A basecoat material, accordingly, is more particularly an interim coating material which imparts color and/or imparts color and an optical effect, used in automotive finishing and general industry coating. It is applied in general to a surfacer- or primer-pretreated metal or plastics substrate, or occasionally directly to the plastics substrate. Other possible substrates include existing finishes, possibly further requiring pretreatment (by sanding, for example). It is now entirely customary for more than one basecoat to be applied. In such a case, accordingly, a first basecoat represents the substrate for a second basecoat. To protect a basecoat, particularly from environmental effects, at least one additional clearcoat is applied over it. A waterborne basecoat material is an aqueous basecoat material in which the fraction of water is >the fraction of organic solvents, based on the total weight of water and organic solvents in % by weight within the waterborne basecoat material.

The fractions in % by weight of all components present in the coating material composition used in accordance with the invention, such as components (a), (b), and (c), and optionally one or more of the further, optional components identified hereinafter, add up to 100% by weight, based on the total weight of the coating material composition.

The solids content of the coating material composition used in accordance with the invention is preferably in a range from 10 to 45% by weight, more preferably from 11 to 42.5% by weight, very preferably from 12 to 40% by weight, more particularly from 13 to 37.5% by weight, based in each case on the total weight of the coating material composition. The solids content, i.e., the nonvolatile fraction, is determined as per the method described hereinafter.

### Component (a)

The term “binder” refers in the sense of the present invention and in agreement with DIN EN ISO 4618 (German version, date: March 2007) preferably to the nonvolatile fractions—those responsible for forming the film—of a composition such as the coating material composition employed in accordance with the invention, with the exception of the pigments and/or fillers it contains. The nonvolatile fraction may be determined according to the method described hereinafter. A binder constituent, accordingly, is any component which contributes to the binder content of a composition such as the coating material composition used in accordance with the invention. An example would be a basecoat material, such as an aqueous basecoat material, which comprises at least one polymer employable as binder as component (a), such as, for example, a below-described SCS polymer; a crosslinking agent such as a melamine resin; and/or a polymeric additive.

Particularly preferred for the use as component (a) is what is called a seed-core-shell polymer (SCS polymer). Such polymers, and aqueous dispersions comprising such polymers, are known from WO 2016/116299 A1, for example. The polymer is preferably a (meth)acrylic copolymer. The polymer is used preferably in the form of an aqueous dispersion. Especially preferred for use as component (a) is a polymer having an average particle size in the range from 100 to 500 nm, preparable by successive radical emulsion polymerization of three monomer mixtures (A), (B), and (C), preferably different from one another, of olefinically unsaturated monomers in water, where

the mixture (A) comprises at least 50% by weight of monomers having a solubility in water of less than 0.5 g/I at 25° C., and a polymer prepared from the mixture (A) possesses a glass transition temperature of 10 to 65° C., the mixture (B) comprises at least one polyunsaturated monomer, and a polymer prepared from the mixture (B) possesses a glass transition temperature of −35 to 15° C., and
a polymer prepared from the mixture (C) possesses a glass transition temperature of −50 to 15° C.,
and wherein
i. first the mixture (A) is polymerized,
ii. then the mixture (B) is polymerized in the presence of the polymer prepared under i., and
iii. thereafter the mixture (C) is polymerized in the presence of the polymer prepared under ii.

The preparation of the polymer comprises the successive radical emulsion polymerization of three mixtures (A), (B), and (C) of olefinically unsaturated monomers in each case in water. It is therefore a multistage radical emulsion polymerization where i. first the mixture (A) is polymerized, then ii. the mixture (B) is polymerized in the presence of the polymer prepared under i. and, furthermore, iii. the mixture (C) is polymerized in the presence of the polymer prepared under ii. All three monomer mixtures are therefore polymerized by a radical emulsion polymerization (i.e. stage or else polymerization stage), carried out separately in each case, with these stages taking place successively. In terms of time, the stages may take place immediately after one another. It is equally possible, after the end of one stage, for the reaction solution in question to be stored for a certain period and/or transferred to a different reaction vessel, and only then for the next stage to be carried out. The preparation of the polymer preferably comprises no polymerization steps other than the polymerization of the monomer mixtures (A), (B), and (C).

The mixtures (A), (B), and (C) are mixtures of olefinically unsaturated monomers. Suitable olefinically unsaturated monomers may be mono- or polyolefinically unsaturated. Examples of suitable monoolefinically unsaturated monomers include, in particular, (meth)acrylate-based monoolefinically unsaturated monomers, monoolefinically unsaturated monomers containing allyl groups, and other monoolefinically unsaturated monomers containing vinyl groups, such as vinylaromatic monomers, for example. The term (meth)acrylic or (meth)acrylate for the purposes of the present invention encompasses both methacrylates and acrylates. Preferred for use at any rate, though not necessarily exclusively, are (meth)acrylate-based monoolefinically unsaturated monomers.

The mixture (A) comprises at least 50% by weight, and preferably at least 55% by weight, of olefinically unsaturated monomers having a water solubility of less than 0.5 g/I at 25° C. One such preferred monomer is styrene. The solubility of the monomers in water is determined by means of the method described hereinafter. The monomer mixture (A) preferably contains no hydroxy-functional monomers. Likewise preferably, the monomer mixture (A) contains no acid-functional monomers. Very preferably the monomer mixture (A) contains no monomers at all that have functional groups containing heteroatoms. This means that heteroatoms, if present, are present only in the form of bridging groups. This is the case, for example, in the (meth)acrylate-based monoolefinically unsaturated monomers described above that possess an alkyl radical as radical R. The monomer mixture (A) preferably comprises exclusively monoolefinically unsaturated monomers. The monomer mixture (A) preferably comprises at least one monounsaturated ester of (meth)acrylic acid with an alkyl radical, and at least one monoolefinically unsaturated monomer containing vinyl groups and having, disposed on the vinyl group, a radical which is aromatic or that is mixed saturated aliphatic-aromatic, in which case the aliphatic fractions of the radical are alkyl groups. The monomers present in the mixture (A) are selected such that a polymer prepared from them possesses a glass transition temperature of 10 to 65° C., preferably of 30 to 50° C. The glass transition temperature here can be determined by means of the method described hereinafter. The polymer prepared in stage i. by the emulsion polymerization of the monomer mixture (A) is also called seed. The seed possesses preferably an average particle size of 20 to 125 nm (measured by dynamic light scattering as described hereinafter; cf. determination methods).

The mixture (B) comprises at least one polyolefinically unsaturated monomer, preferably at least one diolefinically unsaturated monomer. A corresponding preferred monomer is hexanediol diacrylate. The monomer mixture (B) preferably contains no hydroxy-functional monomers. Likewise preferably, the monomer mixture (B) contains no acid-functional monomers. Very preferably, the monomer mixture (B) contains no monomers at all that have functional groups containing heteroatoms. This means that heteroatoms, if present, are present only in the form of bridging groups. This is the case, for example, in the above-described (meth)acrylate-based, monoolefinically unsaturated monomers possessing an alkyl radical as radical R. Besides the at least one polyolefinically unsaturated monomer, the monomer mixture (B) preferably at any rate includes the following monomers: firstly, at least one monounsaturated ester of (meth)acrylic acid with an alkyl radical, and secondly at least one monoolefinically unsaturated monomer containing vinyl groups and having, arranged on the vinyl group, a radical which is aromatic or which is mixed saturated aliphatic-aromatic, in which case the aliphatic fractions of the radical are alkyl groups. The proportion of polyunsaturated monomers is preferably from 0.05 to 3 mol %, based on the total molar amount of monomers in the monomer mixture (B). The monomers present in the mixture (B) are selected such that a polymer prepared therefrom possesses a glass transition temperature of −35 to 15° C., preferably from −25 to +7° C. The glass transition temperature here may be determined by the method described hereinafter. The polymer prepared in the presence of the seed in stage ii. by the emulsion polymerization of the monomer mixture (B) is also referred to as the core. After stage ii., therefore, the resultant polymer comprises seed and core. The polymer which is obtained after stage ii. preferably possesses an average particle size of 80 to 280 nm, preferably 120 to 250 nm (measured by dynamic light scattering as described hereinafter; cf. determination methods).

The monomers present in the mixture (C) are selected such that a polymer prepared therefrom possesses a glass transition temperature of −50 to 15° C., preferably of −20 to +12° C. This glass transition temperature may be determined by the method described hereinafter. The olefinically unsaturated monomers of the mixture (C) are preferably selected such that the resultant polymer, comprising seed, core, and shell, has an acid number of 10 to 25. Accordingly, the mixture (C) preferably comprises at least one alpha-beta unsaturated carboxylic acid, especially preferably (meth)acrylic acid. The olefinically unsaturated monomers in the mixture (C) are preferably selected, additionally or alternatively, in such a way that the resulting polymer, comprising seed, core, and shell, has an OH number of 0 to 30, preferably 10 to 25. All of the aforementioned acid numbers and OH numbers are values calculated on the basis of the entirety of monomer mixtures employed. The monomer mixture (C) preferably comprises at least one alpha-beta unsaturated carboxylic acid and at least one monounsaturated ester of (meth)acrylic acid with an alkyl radical substituted by a hydroxyl group. With particular preference the monomer mixture (C) comprises at least one alpha-beta unsaturated carboxylic acid, at least one monounsaturated ester of (meth)acrylic acid having an alkyl radical substituted by a hydroxyl group, and at least one monounsaturated ester of (meth)acrylic acid with an alkyl radical. Where the present invention refers to an alkyl radical without further particularization, the reference is always to a pure alkyl radical without functional groups and heteroatoms. The polymer prepared in stage iii. by the emulsion polymerization of the monomer mixture (C) in the presence of seed and core is also referred to as the shell. The result after stage iii., therefore, is a polymer which comprises seed, core, and shell, in other words polymer (b). After its preparation, the polymer (B) possesses an average particle size of 100 to 500 nm, preferably 125 to 400 nm, very preferably of 130 to 300 nm (measured by dynamic light scattering as described hereinafter; cf. determination methods).

The coating material composition used in accordance with the invention preferably comprises a fraction of component (a) such as at least one SCS polymer in a range from 1.0 to 20% by weight, more preferably from 1.5 to 19% by weight, very preferably from 2.0 to 18.0% by weight, more particularly from 2.5 to 17.5% by weight, most preferably from 3.0 to 15.0% by weight, based in each case on the total weight of the coating material composition. The determination and specification of the fraction of component (a) within the coating material composition may be made via the determination of the solids content (also called nonvolatile fraction, solids, or solids fraction) of an aqueous dispersion comprising component (a).

Additionally or alternatively, preferably additionally, to the at least one above-described SCS polymer as component (a), the coating material composition used in accordance with the invention may comprise at least one polymer different from the SCS polymer, as binder of component (a), more particularly at least one polymer selected from the group consisting of polyurethanes, polyureas, polyesters, poly(meth)acrylates and/or copolymers of the stated polymers, more particularly polyurethane-poly(meth)acrylates and/or polyurethane-polyureas.

Preferred polyurethanes are described for example in German patent application DE 199 48 004 A1, page 4, line 19 to page 11, line 29 (polyurethane prepolymer B1), in European patent application EP 0 228 003 A1, page 3, line 24 to page 5, line 40, in European patent application EP 0 634 431 A1, page 3, line 38 to page 8, line 9, and in international patent application WO 92/15405, page 2, line 35 to page 10, line 32.

Preferred polyesters are described for example in DE 4009858 A1 in column 6, line 53 to column 7, line 61 and column 10, line 24 to column 13, line 3, or WO 2014/033135 A2, page 2, line 24 to page 7, line 10 and also page 28, line 13 to page 29, line 13.

Preferred polyurethane-poly(meth)acrylate copolymers ((meth)acrylated polyurethanes) and their preparation are described for example in WO 91/15528 A1, page 3, line 21 to page 20, line 33 and also in DE 4437535 A1, page 2, line 27 to page 6, line 22.

Preferred polyurethane-polyurea copolymers are polyurethane-polyurea particles, preferably those having an average particle size of 40 to 2000 nm, where the polyurethane-polyurea particles, in each case in reacted form, comprise at least one polyurethane prepolymer containing isocyanate groups and comprising anionic groups and/or groups which can be converted into anionic groups, and also at least one polyamine containing two primary amino groups and one or two secondary amino groups. Such copolymers are used preferably in the form of an aqueous dispersion. Polymers of these kinds are preparable in principle by conventional polyaddition of, for example, polyisocyanates with polyols and also polyamines. The average particle size of such polyurethane-polyurea particles is determined as described below (measured by means of dynamic light scattering as described hereinafter; cf. determination methods).

The fraction in the coating material composition of such polymers different from the SCS polymer is preferably smaller than the fraction of the SCS polymer. The polymers described are preferably hydroxy-functional and especially preferably possess an OH number in the range from 15 to 200 mg KOH/g, more preferably of 20 to 150 mg KOH/g.

With particular preference the coating material compositions used in accordance with the invention comprise at least one hydroxy-functional polyurethane-poly(meth)acrylate copolymer; with further preference they comprise at least one hydroxy-functional polyurethane poly(meth)acrylate copolymer and also at least one hydroxy-functional polyester and also, optionally, a preferably hydroxy-functional polyurethane-polyurea copolymer.

The fraction of the further polymers as binders of component (a)—additionally to an SCS polymer—may vary widely and is preferably in the range from 1.0 to 25.0% by weight, more preferably 3.0 to 20.0% by weight, very preferably 5.0 to 15.0% by weight, based in each case on the total weight of the coating material composition.

The coating material composition may further comprise at least one conventional, typical crosslinking agent. If it comprises a crosslinking agent, the species in question is preferably at least one amino resin and/or at least one blocked or free polyisocyanate, preferably an amino resin. Among the amino resins, melamine resins in particular are preferred. Where the coating material composition includes crosslinking agents, the fraction of these crosslinking agents, more particularly amino resins and/or blocked or free polyisocyanates, more preferably amino resins, in turn preferably melamine resins, is preferably in the range from 0.5 to 20.0% by weight, more preferably 1.0 to 15.0% by weight, very preferably 1.5 to 10.0% by weight, based in each case on the total weight of the coating material composition. The fraction of crosslinking agent is preferably smaller than the fraction of the SCS polymer in the coating material composition.

### Component (b)

The skilled person is familiar with the terms “pigments” and “fillers”.

The term “filler” is known to the skilled person from DIN 55943 (date: October 2001), for example. A “filler” in the sense of the present invention is preferably a component which is substantially, preferably completely, insoluble in the coating material composition used in accordance with the invention, such as a waterborne basecoat material, for example, and which is used in particular for the purpose of increasing the volume. “Fillers” in the sense of the present invention are preferably different from “pigments” in their refractive index, which for fillers is <1.7. Any customary filler known to the skilled person may be used as component (b). Examples of suitable fillers are kaolin, dolomite, calcite, chalk, calcium sulfate, barium sulfate, graphite, silicates such as magnesium silicates, especially corresponding phyllosilicates such as hectorite, bentonite, montmorillonite, talc and/or mica, silicas, especially fumed silicas, hydroxides such as aluminum hydroxide or magnesium hydroxide, or organic fillers such as textile fibers, cellulose fibers, polyethylene fibers or polymer powders.

The term “pigment” is likewise known to the skilled person, from DIN 55943 (date: October 2001), for example. A “pigment” in the sense of the present invention refers preferably to components in powder or platelet form which are substantially, preferably entirely, insoluble in the coating material composition used in accordance with the invention, such as a waterborne basecoat material, for example. These “pigments” are preferably colorants and/or substances which can be used as pigment by virtue of their magnetic, electrical and/or electromagnetic properties. Pigments differ from “fillers” preferably in their refractive index, which for pigments is 1.7.

The term “pigments” preferably subsumes color pigments and effect pigments.

A skilled person is familiar with the concept of color pigments. For the purposes of the present invention, the terms “color-imparting pigment” and “color pigment” are interchangeable. A corresponding definition of the pigments and further specifications thereof are dealt with in DIN 55943 (date: October 2001). Color pigment used may comprise organic and/or inorganic pigments. Particularly preferred color pigments used are white pigments, chromatic pigments and/or black pigments. Examples of white pigments are titanium dioxide, zinc white, zinc sulfide, and lithopones. Examples of black pigments are carbon black, iron manganese black, and spinel black. Examples of chromatic pigments are chromium oxide, chromium oxide hydrate green, cobalt green, ultramarine green, cobalt blue, ultramarine blue, manganese blue, ultramarine violet, cobalt and manganese violet, red iron oxide, cadmium sulfoselenide, molybdate red and ultramarine red, brown iron oxide, mixed brown, spinel phases and corundum phases, and chromium orange, yellow iron oxide, nickel titanium yellow, chromium titanium yellow, cadmium sulfide, cadmium zinc sulfide, chromium yellow, and bismuth vanadate.

A skilled person is familiar with the concept of effect pigments. A corresponding definition is found for example in Römpp Lexikon, Lacke and Druckfarben, Georg Thieme Verlag, 1998, 10^{th} edition, pages 176 and 471. A definition of pigments in general and further particularizations thereof are dealt with in DIN 55943 (date: October 2001). Effect pigments are preferably pigments which impart optical effect or color and optical effect, especially optical effect. The terms “optical effect-imparting and color-imparting pigment”, “optical effect pigment” and “effect pigment” are therefore preferably interchangeable. Preferred effect pigments are, for example, platelet-shaped metallic effect pigments such as leaflet-like aluminum pigments, gold bronzes, oxidized bronzes and/or iron oxide-aluminum pigments, pearlescent pigments such as pearl essence, basic lead carbonate, bismuth oxychloride and/or metal oxide-mica pigments and/or other effect pigments such as leaflet-like graphite, leaflet-like iron oxide, multilayer effect pigments from PVD films and/or liquid crystal polymer pigments. Particularly preferred are effect pigments in leaflet form, especially leaflet-like aluminum pigments and metal oxide-mica pigments.

The coating material composition used in accordance with the invention, such as a waterborne basecoat material, for example, with particular preference includes at least one effect pigment as component (b).

The coating material composition used in accordance with the invention preferably comprises a fraction of effect pigment as component (b) in a range from 1 to 20% by weight, more preferably from 1.5 to 18% by weight, very preferably from 2 to 16% by weight, more particularly from 2.5 to 15% by weight, most preferably from 3 to 12% by weight or from 3 to 10% by weight, based in each case on the total weight of the coating material composition. The total fraction of all pigments and/or fillers in the coating material composition is preferably in the range from 0.5 to 40.0% by weight, more preferably from 2.0 to 20.0% by weight, very preferably from 3.0 to 15.0% by weight, based in each case on the total weight of the coating material composition.

The relative weight ratio of component (b) such as at least one effect pigment to component (a) such as at least one SCS polymer in the coating material composition is preferably within a range from 4:1 to 1:4, more preferably in a range from 2:1 to 1:4, very preferably in a range from 2:1 to 1:3, more particularly in a range from 1:1 to 1:3 or from 1:1 to 1:2.5.

### Component (c)

The coating material composition used in accordance with the invention is preferably aqueous. It is preferably a system comprising as its solvent (i.e., as component (c)) primarily water, preferably in an amount of at least 20% by weight, and organic solvents in smaller fractions, preferably in an amount of <20% by weight, based in each case on the total weight of the coating material composition.

The coating material composition used in accordance with the invention preferably comprises a fraction of water of at least 20% by weight, more preferably of at least 25% by weight, very preferably of at least 30% by weight, more particularly of at least 35% by weight, based in each case on the total weight of the coating material composition.

The coating material composition used in accordance with the invention preferably comprises a fraction of water that is within a range from 20 to 65% by weight, more preferably in a range from 25 to 60% by weight, very preferably in a range from 30 to 55% by weight, based in each case on the total weight of the coating material composition.

The coating material composition used in accordance with the invention preferably comprises a fraction of organic solvents that is within a range of <20% by weight, more preferably in a range from 0 to <20% by weight, very preferably in a range from 0.5 to <20% by weight or to 15% by weight, based in each case on the total weight of the coating material composition.

Examples of such organic solvents include heterocyclic, aliphatic or aromatic hydrocarbons, mono- or polyhydric alcohols, especially methanol and/or ethanol, ethers, esters, ketones, and amides, such as N-methylpyrrolidone, M-ethylpyrrolidone, dimethylformamide, toluene, xylene, butanol, ethyl glycol and butyl glycol and also their acetates, butyl diglycol, diethylene glycol dimethyl ether, cyclohexanone, methyl ethyl ketone, methyl isobutyl ketone, acetone, isophorone, or mixtures thereof.

### Further Optional Components

The coating material composition used in accordance with the invention may optionally further comprise at least one thickener (also referred to as thickening agent) as component (d). Examples of such thickeners are inorganic thickeners, as for example metal silicates such as phyllosilicates, and organic thickeners, as for example poly(meth)acrylic acid thickeners and/or (meth)acrylic acid-(meth)acrylate copolymer thickeners, polyurethane thickeners, and also polymeric waxes. The metal silicate is selected preferably from the group of the smectites. The smectites are selected with particular preference from the group of the montmorillonites and hectorites. The montmorillonites and hectorites are selected more particularly from the group consisting of aluminum magnesium silicates and also sodium magnesium phyllosilicates and sodium magnesium fluorine lithium phyllosilicates. These inorganic phyllosilicates are sold under the brand name Laponite®, for example. Thickeners based on poly(meth)acrylate and (meth)acrylic acid-(meth)acrylate copolymer thickeners are optionally crosslinked and/or neutralized with a suitable base. Examples of such thickening agents are “alkali swellable emulsions” (ASEs) and hydrophobically modified variants of them, the “hydrophobically modified alkali swellable emulsions” (HASEs). These thickeners are preferably anionic. Corresponding products such as Rheovis® AS 1130 are available commercially. Thickeners based on polyurethanes (e.g., polyurethane associative thickeners) are optionally crosslinked and/or neutralized with a suitable base. Corresponding products such as Rheovis® PU 1250 are available commercially. Examples of suitable polymeric waxes include optionally modified polymeric waxes based on ethylene-vinyl acetate copolymers. A corresponding product is available commercially under the designation Aquatix® 8421, for example.

Depending on desired application, the coating material composition used in accordance with the invention may comprise one or more commonly employed additives as further component or components (d). By way of example, the coating material composition may comprise at least one additive selected from the group consisting of reactive diluents, light stabilizers, antioxidants, deaerating agents, emulsifiers, slip additives, polymerization inhibitors, initiators for radical polymerizations, adhesion promoters, flow control agents, film-forming assistants, sag control agents (SCAs), flame retardants, corrosion inhibitors, siccatives, biocides, and flattening agents. They may be used in the known and customary proportions.

The coating material composition used in accordance with the invention may be produced using the customary and known mixing methods and mixing units.

### Coating of the Invention

A further subject of the present invention is at least one coating (B1) located on a substrate, this coating being obtainable in accordance with the method of the invention.

All preferred embodiments described hereinabove in connection with the method of the invention for producing the coating (B1) are also preferred embodiments in relation to the coating (B1) obtainable by means of this method.

Relative to a coating obtainable by the method of the invention but without implementation of step (3), the coating (B1) preferably has a smaller number of surface defects and/or optical defects. More particularly, the coating (B1), relative to a coating obtainable by the method of the invention but without implementation of step (3), has an improved appearance and/or an improved pinholing robustness.

Preferably, the surface defects and/or optical defects are selected from the group of pinholes, pops, runs, cloudiness and/or the appearance (visual aspect). As already mentioned, the coating (B1) is preferably a basecoat such as a waterborne basecoat, which may in turn be part of a multicoat paint system. Incidence of pinholes is investigated and assessed in accordance with the method of determination described hereinafter, by counting of the pinholes on wedge application of the coating to a substrate in a film thickness range from 0 to 40 μm (dry film thickness), with the ranges from 0 to 20 μm and from >20 to 40 μm being counted separately; standardization of the results to an area of 200 cm²; and summation to give a total number. Preferably just a single pinhole is a defect. The incidence of pops is investigated and assessed in accordance with the method of determination described hereinafter, by determination of the popping limit, i.e., the film thickness of a coating, such as a basecoat, from which pops occur, in accordance with DIN EN ISO 28199-3, section 5 (date: January 2010). With preference just a single pop is a defect. Incidence of cloudiness is investigated and assessed in accordance with the method of determination described hereinafter using the cloud-runner instrument from BYK-Gardner GmbH, with determination of the three characteristic variables of “mottling15”, “mottling45”, and “mottling60” as measures of the cloudiness, measured at the angles of 15°, 45°, and 60° relative to the angle of reflection of the measurement light source used; the higher the value of the corresponding characteristic variable or variables, the more pronounced the cloudiness. Appearance is investigated and assessed in accordance with the method of determination described hereinafter, by assessing the leveling on wedge application of the coating to a substrate in a film thickness range from 0 to 40 μm (dry film thickness), with different regions, such as 10-15 μm, 15-20 μm, and 20-25 μm, for example, being marked, and with the investigation and assessment being performed within these film thickness regions using the Wave scan instrument from Byk-Gardner GmbH. In that case a laser beam is directed at an angle of 60° onto the surface to be investigated, and over a measuring distance of 10 cm the fluctuations of the reflected light in the short wave region (0.3 to 1.2 mm) and in the long wave region (1.2 to 12 mm) are recorded by means of the instrument (long wave=LW; short wave=SW; the lower the figures, the better the leveling). Incidence of runs is investigated and assessed in accordance with the method of determination described hereinafter, by determination of the running tendency in accordance with DIN EN ISO 28199-3, section 4 (date: January 2010). A defect occurs, preferably, when runs occur starting from a film thickness which is below a film thickness amounting to 125% of the target film thickness. For example, if the target film thickness is 12 μm, a defect occurs if there are runs at a film thickness of 12 μm+25%, in other words at 16 μm. Film thicknesses here are determined in each case in accordance with DIN EN ISO 2808 (date: May 2007), method 12A, preferably using the MiniTest® 3100-4100 instrument from ElektroPhysik. In all cases the thickness in question is the dry film thickness in each case.

The skilled person knows the terms “pinholes”, “pops”, “runs”, and “leveling”, from Römpp Chemie Lexikon, Lacke and Druckfarben, 1998, 10^{th} edition, for example. The concept of cloudiness is likewise one known to the skilled person. The cloudiness of a paint finish is understood according to DIN EN ISO 4618 (date: January 2015) to refer to the disparate appearance of a finish due to irregular regions, distributed randomly over the surface, that differ in their color and/or gloss. A dappled inhomogeneity of this kind is disruptive to the uniform overall impression conveyed by the finish, and is generally undesirable. A method for determining the cloudiness is specified hereinafter.

### Determination Methods

### 1. Determination of Nonvolatile Fraction

The nonvolatile fraction (the solids content) is determined according to DIN EN ISO 3251 (date: June 2008). 1 g of sample is weighed out into an aluminum dish which has been dried beforehand and the dish with sample is dried in a drying cabinet at 125° C. for 60 minutes, cooled in a desiccator, and then reweighed. The residue relative to the total amount of sample used corresponds to the nonvolatile fraction. The volume of the nonvolatile fraction may be determined if necessary, in accordance with DIN 53219 (date: August 2009) optionally.

### 2. Determination of Number-Average Molecular Weight

The number-average molecular weight (Mₙ) is determined, unless otherwise specified, using a model 10.00 vapor pressure osmometer (from Knauer) on concentration series in toluene at 50° C. with benzophenone as a calibration substance for determining the experimental calibration constant of the instrument used, in accordance with E. Schröder, G. Müller, K.-F. Arndt, “Leitfaden der Polymercharakterisierung” [Principles of polymer characterization], Akademie-Verlag, Berlin, pp. 47-54, 1982.

### 3. Determination of OH Number and of Acid Number

The OH number and the acid number are each determined by calculation.

### 4. Determination of Average Particle Size of SCS Polymers and Polyurethane-Polyurea Particles

The average particle size is determined by dynamic light scattering (photon correlation spectroscopy) (PCS) in a method based on DIN ISO 13321 (date: October 2004). Measurement takes place using a Malvern Nano S90 (from Malvern Instruments) at 25±1° C. The instrument covers a size range from 3 to 3000 nm and is equipped with a 4 mW He—Ne laser at 633 nm. The respective samples are diluted with particle-free deionized water as dispersing medium and then measured in a 1 ml polystyrene cuvette at suitable scattering intensity. Evaluation took place using a digital correlator with assistance from the Zetasizer evaluation software 7.11 (from Malvern Instruments). Measurement is carried out five times and the measurements are repeated on a second, freshly prepared sample. For the SCS polymer, the average particle size refers to the arithmetic numerical mean of the measured average particle diameter (Z-average mean; numerical average; d_{N,50%}). The standard deviation of a 5-fold determination in this case is ≤4%. For the polyurethane-polyurea particles that can be employed, the average particle size refers to the arithmetic volume mean of the average particle size of the individual preparations (V-average mean; volume average; d_{V,50%}). The maximum deviation of the volume average from five individual measurements is ±15%. Verification takes place with polystyrene standards each having certified particle sizes between 50 to 3000 nm.

### 5. Determination of Film Thicknesses

The film thicknesses are determined in accordance with DIN EN ISO 2808 (date: May 2007), method 12A, using the MiniTest® 3100-4100 instrument from ElektroPhysik.

### 6. Assessment of the Incidence of Pinholes and the Film Thickness-Dependent Leveling

To assess the incidence of pinholes and the film thickness-dependent leveling, wedge-format multicoat paint systems are produced in accordance with the following general protocol:

a steel panel with dimensions of 30×50 cm, coated with a standard cathodic electrocoat (CathoGuard® 800 from BASF Coatings GmbH), is provided at one longitudinal edge with an adhesive strip (Tesaband, 19 mm) to allow determination of film thickness differences after coating. A waterborne basecoat material is applied electrostatically as a wedge with a target film thickness (film thickness of the dried material) of 0-40 μm. The discharge rate here is between 300 and 400 ml/min, the rotary speed of the ESTA bell is varied between 23 000 and 43 000 rpm; the exact figures for each of the application parameters specifically selected are stated below within the experimental section. After a flash-off time of 4-5 minutes at room temperature (18 to 23° C.), the system is dried in a forced air oven at 60° C. for 10 minutes. Following removal of the adhesive strip, a commercial two-component clearcoat material (ProGloss® from BASF Coatings GmbH) is applied by gravity-fed spray gun, manually, to the dried waterborne basecoat film, with a target film thickness (film thickness of the dried material) of 40-45 μm. The resulting clearcoat film is flashed off at room temperature (18 to 23° C.) for 10 minutes; this is followed by curing in a forced air oven at 140° C. for a further 20 minutes.

Incidence of pinholes is assessed visually according to the following general protocol: the dry film thickness of the waterborne basecoat is checked, and for the basecoat film thickness wedge, the ranges of 0-20 μm and also of 20 μm to the end of the wedge are marked on the steel panel. The pinholes are evaluated visually in the two separate regions of the waterborne basecoat wedge. The number of pinholes per region is counted. All results are standardized to an area of 200 cm² and then summed to give a total number. Additionally, where appropriate, a record is made of the dry film thickness of the waterborne basecoat wedge from which pinholes no longer occur.

The film thickness-dependent leveling is assessed according to the following general protocol: the dry film thickness of the waterborne basecoat is checked, and for the basecoat film thickness wedge, different regions, for example 10-15 μm, 15-20 μm, and 20-25 μm, are marked on the steel panel. The film thickness-dependent leveling is determined and assessed using the Wave scan instrument from Byk-Gardner GmbH, within the basecoat film thickness regions ascertained beforehand. For this purpose, a laser beam is directed at an angle of 60° onto the surface under investigation, and fluctuations in the reflected light in the short wave range (0.3 to 1.2 mm) and in the long wave range (1.2 to 12 mm) are recorded by the instrument over a measuring distance of 10 cm (long wave=LW; short wave=SW; the lower the figures, the better the appearance). Furthermore, as a measure of the sharpness of an image reflected in the surface of the multicoat system, the characteristic parameter of “distinctness of image” (DOI) is determined with the aid of the instrument (the higher the value, the better the appearance).

### 7. Determination of Cloudiness

For determining the cloudiness, multicoat paint systems are produced according to the following general protocol:

A steel panel with dimensions 32×60 cm, coated with a conventional surfacer system, is further coated with a waterborne basecoat material by means of dual application; application in the first step is made electrostatically with a target film thickness of 8-9 μm, and in the second step, after a 2-minute flash-off time at room temperature, it is made likewise electrostatically with a target film thickness of 4-5 μm. After a further flash-off time at room temperature (18 to 23° C.) of 5 minutes, the resulting waterborne basecoat film is dried in a forced air oven at 80° C. for 5 minutes.

Both basecoat applications are made with a rotary speed of 43 000 rpm and a discharge rate of 300 ml/min. Applied atop the dried waterborne basecoat film is a commercial two-component clearcoat material (ProGloss from BASF Coatings GmbH), with a target film thickness of 40-45 μm. The resulting clearcoat film is flashed off at room temperature (18 to 23° C.) for 10 minutes; this is followed by curing in a forced air oven at 140° C. fora further 20 minutes.

The cloudiness is then assessed using the cloud-runner instrument from BYK-Gardner GmbH in accordance with alternative b). The instrument outputs parameters including the three characteristic parameters of “mottling15”, “mottling45”, and “mottling60”, which can be seen as a measure of the cloudiness measured at angles of 15°, 45°, and 60° relative to the reflection angle of the measurement light source used. The higher the value, the more pronounced the cloudiness.

### 8. Assessment of Streakiness

The streakiness is assessed by means of the method described in patent specification DE 10 2009 050 075 B4. The homogeneity indices stated and defined therein, or the averaged homogeneity index, are equally able to capture the incidence of streaks in the application, despite those indices having been used in the stated patent specification for the purpose of assessing cloudiness. The higher the corresponding values, the more pronounced the streaks visible on the substrate.

9. Determining the Particle Size Distribution Including the D₁₀ and Also the Ratio of the Characteristic Variables T_{T1}/T_{Total1} and T_{T2}/T_{Total2} as a Measurement of the Homogeneity of the Spray Arising from Atomization, by Means of the Method of the Invention

The parent particle size distributions are determined using a commercial single PDA from DantecDynamics (P60, Lexel argon laser, FibreFlow) and also a commercial time-shift instrument from AOM Systems (SpraySpy®). Both instruments are constructed and aligned in accordance with the manufacturer information. The settings for the time-shift instrument SpraySpy® are adapted by the manufacturer for the range of materials to be used. The PDA is operated in forward scattering at an angle of 60-70° with a wavelength of 514.5 nm (orthogonally polarized) in reflection. The receiving optics here have a focal length of 500 mm, the transmitting optics a focal length of 400 mm. For both systems, the construction is aligned relative to the atomizer. The general construction is evident from FIG. 1. In FIG. 1 a rotational atomizer has been used as the atomizer, by way of example. Measurement is made traversingly in a radial-axial direction in relation to the tilted atomizer (tilt angle 45°), 25 mm vertically below the atomizer flank inclined to the traversing axis. In this case a defined traversing velocity is predetermined, and so spatial resolution of the individual events detected takes place via the associated time-resolved signals. A comparison to raster-resolved measurements yields identical results for the weighted global distribution characteristics, but also allows the investigation of any desired interval ranges on the traversing axis. Moreover, this method is faster by a multiple than rastering, thereby allowing a reduction in the expenditure on the material for constant flow rates. The detectable drops are captured with maximum validation tolerance. The raw data are then evaluated via an algorithm for any desired tolerances. A tolerance of around 10% for the PDA system used limits the validation to spherical particles; an increase also draws slightly deformed drops into the consideration. As a result, consideration of the sphericity of the measured drops along the measurement axis is made possible. The SpraySpy® system is capable of distinguishing between transparent and nontransparent drops. The measurement axis (see diagram according to FIG. 1) is traveled repeatedly and both measurement methods are employed. Duplicate measurement of the individual events is prevented by the system's internal analysis facility. The data thus obtained can therefore be evaluated for the transparent spectrum (T) and for the nontransparent spectrum (NT). The ratio of the number of measured drops in both spectra serves as a measure of the local distribution of transparent and nontransparent drops. An integral appraisal along the measurement axis is possible. Specifically, the ratio of the transparent particles (T) to the total number of particles (Total) is determined at a position 1 of x=5 mm and at a position 2 of x=25 mm along the measurement axis; a ratio is formed in turn from the corresponding values, in order to describe the changing homogeneity of the spray jet from inside to outside. For both systems, single PDA and SpraySpy®, the raw data can be used as a basis for determining customary distribution moments such as D₁₀ values, for example.

10. Determining the Solubility of the Monomers of the Mixture (A) in Water that can be Used for Preparing SCS Polymers

The solubility of the monomers in water is determined via establishment of equilibrium with the gas space above the aqueous phase (in analogy to the reference X.-S. Chai, Q. X. Hou, F. J. Schork, Journal of Applied Polymer Science vol. 99, 1296-1301 (2006)). For this purpose, in a 20 ml gas space sample tube, a defined volume of water, such as 2 ml, is admixed with the respective monomer in a mass so great that it is unable to dissolve, or at any rate to dissolve completely, in the volume of water selected. Additionally an emulsifier (10 ppm, based on total mass of the sample mixture) is added. To obtain the equilibrium concentration, the mixture is shaken continually. The supernatant gas phase is replaced by inert gas, thus re-establishing an equilibrium. In the gas phase removed, the fraction of the substance to be detected is measured (by means of gas chromatography, for example). The equilibrium concentration in water can be determined by plotting the fraction of the monomer in the gas phase as a graph. The slope of the curve changes from a virtually constant value (51) to a significantly negative slope (S2) as soon as the excess monomer fraction has been removed from the mixture. The equilibrium concentration here is reached at the point of intersection of the straight line with the slope 51 and of the straight line with the slope S2. The determination described is carried out at 25° C.

11. Determination of Glass Transition Temperatures of Polymers Obtainable from Monomers of Mixtures (A), (B), and (C), Respectively

The glass transition temperature T_{g} is determined experimentally in a method based on DIN 51005 (date: August 2005) “Thermal Analysis (TA)—terms” and DIN 53765 “Thermal Analysis—Dynamic Scanning calorimetry (DSC)” (date: March 1994). This involves weighing out a 15 mg sample into a sample boat and introducing the boat into a DSC instrument. Cooling takes place to the starting temperature, after which 1^{st} and 2^{nd} measurement runs are carried out under inert gas purging (N₂) of 50 ml/min at a heating rate of 10 K/min, with cooling back to the starting temperature between the measurement runs. Measurement takes place in the temperature range from approximately 50° C. lower than the expected glass transition temperature to approximately 50° C. higher than the expected glass transition temperature. The glass transition temperature recorded, in accordance with DIN 53765, section 8.1, is the temperature in the 2^{nd} measurement run at which half of the change in specific heat capacity (0.5 delta cp) has been reached. It is determined from the DSC diagram (plot of heat flow against temperature). It is the temperature corresponding to the point of intersection of the midline between the extrapolated baselines before and after the glass transition with the measurement plot. For a useful estimation of the glass transition temperature to be expected in the measurement, the known Fox equation can be employed. Since the Fox equation represents a good approximation, based on the glass transition temperatures of the homopolymers and their parts by weight without including the molecular weight, it may be used as a useful tool for the skilled person at the synthesis stage, allowing a desired glass transition temperature to be set via a few goal-directed trials.

### 12. Determination of Wetness

An assessment is made of the wetness of a film formed by application to a substrate of a coating material composition such as a waterborne basecoat material. The coating material composition in this case is applied electrostatically by means of rotational atomizing as a constant layer in the desired target film thickness (film thickness of the dried material) such as a target film thickness within a range from 15 μm to 40 μm. The discharge rate is between 300 and 400 ml/min and the rotary speed of the ESTA bell of the rotational atomizer is in a range from 23 000 to 63 000 rpm (the precise details of the application parameters specifically selected in each case are stated at the relevant points hereinafter within the experimental section). A visual assessment of the wetness of the film formed on the substrate is made one minute after the end of application. The wetness is recorded on a scale from 1 to 5 (1=very dry to 5=very wet).

### 13. Determination of the Incidence of Pops

To determine the propensity toward popping, a multicoat paint system is produced in a method based on DIN EN ISO 28199-1 (date: January 2010) and DIN EN ISO 28199-3 (date: January 2010) in accordance with the following general protocol: a perforated steel plate with dimensions of 57 cm×20 cm (according to DIN EN ISO 28199-1, section 8.1, version A), coated with a cured cathodic electrocoat (EC) (CathoGuard® 800 from BASF Coatings GmbH), is prepared in an analogy to DIN EN ISO 28199-1, section 8.2 (version A). This is followed, in a method based on DIN EN ISO 28199-1, section 8.3, by electrostatic application of an aqueous basecoat material in a single application in the form of a wedge with a target film thickness (film thickness of the dried material; dry film thickness) in the range from 0 μm to 30 μm. The resulting basecoat film, without a flash-off time beforehand, is subjected to interim drying in a forced air oven at 80° C. for 5 minutes. The determination of the popping limit, i.e., of the basecoat film thickness from which pops occur, is made according to DIN EN ISO 28199-3, section 5.

### 14. Determination of the Incidence of Runs

To determine the propensity toward running, multicoat paint systems are produced in a method based on DIN EN ISO 28199-1 (date: January 2010) and DIN EN ISO 28199-3 (date: January 2010) in accordance with the following general protocol:

### a) Waterborne Basecoat Materials

A perforated steel plate with dimensions of 57 cm×20 cm (according to DIN EN ISO 28199-1, section 8.1, version A), coated with a cured cathodic electrocoat (EC) (CathoGuard® 800 from BASF Coatings GmbH), is prepared in an analogy to DIN EN ISO 28199-1, section 8.2 (version A). This is followed, in a method based on DIN EN ISO 28199-1, section 8.3, by electrostatic application of an aqueous basecoat material in a single application in the form of a wedge with a target film thickness (film thickness of the dried material) in the range from 0 μm to 40 μm. The resulting basecoat film, after a flash-off time at 18-23° C. of 10 minutes, is subjected to interim drying in a forced air oven at 80° C. for 5 minutes. The panels here are flashed off and subjected to interim drying while standing vertically.

### b) Clearcoat Materials:

A perforated steel plate with dimensions of 57 cm×20 cm (according to DIN EN ISO 28199-1, section 8.1, version A), coated with a cured cathodic electrocoat (EC) (CathoGuard® 800 from BASF Coatings GmbH) and a commercially available waterborne basecoat material (ColorBrite from BASF Coatings GmbH), is prepared in an analogy to DIN EN ISO 28199-1, section 8.2 (version A). This is followed, in a method based on DIN EN ISO 28199-1, section 8.3, by electrostatic application of a clearcoat material in a single application in the form of a wedge with a target film thickness (film thickness of the dried material) in the range from 0 μm to 60 μm. The resulting clearcoat film, after a flash-off time at 18-23° C. of 10 minutes, is cured in a forced air oven at 140° C. for 20 minutes. The panels here are flashed off and cured while standing vertically.

The propensity toward running is determined in each case in accordance with DIN EN ISO 28199-3, section 4. In addition to the film thickness at which a run exceeds a length of 10 mm from the bottom edge of the perforation, a determination is made of the film thickness from which a first propensity to run at a perforation can be observed visually.

### 15. Determination of the Hiding Power

The hiding power is determined according to DIN EN ISO 28199-3 (January 2010; section 7).

### Inventive and Comparative Examples

The inventive and comparative examples below serve to illustrate the invention, but should not be interpreted as limiting.

Unless otherwise stated, the figures in parts are parts by weight, and figures in percent are percentages by weight in each case.

### 1. Preparation of an Aqueous Dispersion AD1

1.1 The meanings of the components identified below and used in preparing the aqueous dispersion AD1 are as follows:

DMEA dimethylethanolamine
DI water deionized water
EF 800 Aerosol® EF-800, commercially available emulsifier from Cytec
APS ammonium peroxodisulfate
1,6-HDDA 1,6-hexanediol diacrylate
2-HEA2-hydroxyethyl acrylate
MMA methyl methacrylate

1.2 Preparation of the aqueous dispersion AD1 comprising a multistage SCS polyacrylate

### Monomer Mixture (A), Stage i.

80 wt % of items 1 and 2 as per table 1.1 below are placed in a steel reactor (5 L volume) with reflux condenser and are heated to 80° C. The remaining fractions of the components listed under “Initial charge” in table 1.1 are premixed in a separate vessel. This mixture and, separately therefrom, the initiator solution (table 1.1, items 5 and 6) are added dropwise to the reactor simultaneously over the course of 20 minutes, a fraction of the monomers in the reaction solution, based on the total amount of monomers used in stage i., not exceeding 6.0 wt % throughout the reaction time. 30 minutes of stirring follow.

### Monomer Mixture (B), Stage ii.

The components indicated under “Mono 1” in table 1.1 are premixed in a separate vessel. This mixture is added dropwise to the reactor over the course of 2 hours, a fraction of the monomers in the reaction solution, based on the total amount of monomers used in stage ii., not exceeding 6.0 wt % throughout the reaction time. 1 hour of stirring follows.

### Monomer Mixture (C), Stage iii.

The components indicated under “Mono 2” in table 1.1 are premixed in a separate vessel. This mixture is added dropwise to the reactor over the course of 1 hour, a fraction of the monomers in the reaction solution, based on the total amount of monomers used in stage iii., not exceeding 6.0 wt % throughout the reaction time. 2 hours of stirring follows.

Thereafter the reaction mixture is cooled to 60° C. and the neutralizing mixture (table 1.1, items 20, 21, and 22) is premixed in a separate vessel. The neutralizing mixture is added dropwise to the reactor over the course of 40 minutes, the pH of the reaction solution being adjusted to a pH of 7.5 to 8.5. The reaction product is subsequently stirred for 30 minutes more, cooled to 25° C., and filtered.

The solids content of the resulting aqueous dispersion AD1 was determined for reaction monitoring. The result, together with the pH and the particle size determined, is reported in table 1.2.

TABLE 1.1
Aqueous dispersion AD1 comprising a multistage polyacrylate

| | | AD1 |
|---|---|---|
| | Initial charge | |
| 1 | DI water | 41.81 |
| 2 | EF 800 | 0.18 |
| 3 | Styrene | 0.68 |
| 4 | n-Butyl acrylate | 0.48 |
| | Initiator solution | |
| 5 | DI water | 0.53 |
| 6 | APS | 0.02 |
| | Mono 1 | |
| 7 | DI water | 12.78 |
| 8 | EF 800 | 0.15 |
| 9 | APS | 0.02 |
| 10 | Styrene | 5.61 |
| 11 | n-Butyl acrylate | 13.6 |
| 12 | 1,6-HDDA | 0.34 |
| | Mono 2 | |
| 13 | DI water | 5.73 |
| 14 | EF 800 | 0.07 |
| 15 | APS | 0.02 |
| 16 | Methacrylic acid | 0.71 |
| 17 | 2-HEA | 0.95 |
| 18 | n-Butyl acrylate | 3.74 |
| 19 | MMA | 0.58 |
| | Neutralizing | |
| 20 | DI water | 6.48 |
| 21 | Butyl glycol | 4.76 |
| 22 | DMEA | 0.76 |

TABLE 1.2
Characteristics of the aqueous dispersion
AD1 or of the polymer comprised

| | AD1 |
|---|---|
| Solids content [wt %] | 25.6 |
| pH | 8.85 |
| Particle size [nm] | 246 |

### 2. Preparation of an Aqueous Polyurethane-Polyurea Dispersion PD1

### Preparation of a Partially Neutralized Prepolymer Solution

In a reaction vessel equipped with stirrer, internal thermometer, reflux condenser and electrical heating, 559.7 parts by weight of a linear polyester polyol and 27.2 parts by weight of dimethylolpropionic acid (from GEO Speciality Chemicals) were dissolved under nitrogen in 344.5 parts by weight of methyl ethyl ketone. The linear polyester diol was prepared beforehand from dimerized fatty acid (Pripol® 1012, Croda), isophthalic acid (from BP Chemicals) and hexane-1,6-diol (from BASF SE) (weight ratio of the starting materials: dimeric fatty acid to isophthalic acid to hexane-1,6-diol=54.00:30.02:15.98) and had a hydroxyl number of 73 mg KOH/g solids fraction, an acid number of 3.5 mg KOH/g solids fraction, a calculated number-average molecular weight of 1379 g/mol, and a number-average molecular weight as determined by vapor pressure osmometry of 1350 g/mol. Added to the resulting solution at 30° C. in succession were 213.2 parts by weight of dicyclohexylmethane 4,4′-diisocyanate (Desmodur® W, Covestro AG), with an isocyanate content of 32.0 wt %, and 3.8 parts by weight of dibutyltin dilaurate (from Merck). This was followed by heating to 80° C. with stirring. Stirring continued at this temperature until the isocyanate content of the solution was constant at 1.49 wt %. Thereafter 626.2 parts by weight of methyl ethyl ketone were added to the prepolymer and the reaction mixture was cooled to 40° C. When 40° C. was reached, 11.8 parts by weight of triethylamine (from BASF SE) were added dropwise over the course of two minutes, and the batch was stirred for a further five minutes.

Reaction of the Prepolymer with Diethylenetriamine Diketimine

30.2 parts by weight of a 71.9 wt % dilution of diethylenetriamine diketimine in methyl isobutyl ketone (ratio of prepolymer isocyanate groups with diethylenetriamine diketimine (having one secondary amino group): 5:1 mol/mol, corresponding to two NCO groups per blocked primary amino group) were subsequently admixed over the course of a minute, with the reaction temperature rising briefly by 1° C. following addition to the prepolymer solution. The diluted preparation of diethylenetriamine diketimine in methyl isobutyl ketone was prepared beforehand by azeotropic removal of water of reaction during the reaction of diethylenetriamine (from BASF SE) with methyl isobutyl ketone in methyl isobutyl ketone at 110-140° C. Dilution with methyl isobutyl ketone was used to set an amine equivalent mass (solution) of 124.0 g/eq. IR spectroscopy, on the basis of the residual absorption at 3310 cm⁻¹, found 98.5% blocking of the primary amino groups. The solids content of the polymer solution containing isocyanate groups was found to be 45.3%.

### Dispersing and Vacuum Distillation

After 30 minutes of stirring at 40° C., the contents of the reactor were dispersed over 7 minutes into 1206 parts by weight of deionized water (23° C.). Methyl ethyl ketone was distilled off under reduced pressure from the resulting dispersion at 45° C., and any losses of solvent and of water were made up with deionized water, to give a solids content of 40 wt %. The resulting dispersion was white, stable, high in solids content and low in viscosity, contained crosslinked particles, and showed no sedimentation at all even after three months.

The characteristics of the resulting microgel dispersion (PD1) were as follows:

| Solids content (130° C., 60 min, 1 g): | 40.2 | wt % |
|---|---|---|
| Methyl ethyl ketone content (GC): | 0.2 | wt % |
| Methyl isobutyl ketone content (GC): | 0.1 | wt % |
| Viscosity (23° C., rotational viscometer, | 15 | mPa · s |
| shear rate = 1000/s): | | |
| Acid number: | 17.1 mg KOH/g solids content | |
| Degree of neutralization (calculated): | 49% | |
| pH (23° C.): | 7.4 | |
| Particle size (photon correlation | 167 | nm |
| spectroscopy, volume average): | | |
| Gel fraction (freeze-dried): | 85.1 | wt % |
| Gel fraction (130° C.): | 87.3 | wt % |

### 3. Preparation of Colorant and Filler Pastes

### 3.1 Production of a Yellow Paste P1

The yellow paste P1 is produced from 17.3 parts by weight of Sicotrans yellow L 1916, available from BASF SE, 18.3 parts by weight of a polyester prepared as per example D, column 16, lines 37-59 of DE 40 09 858 A1, 43.6 parts by weight of a binder dispersion prepared as per international patent application WO 92/15405, page 15, lines 23-28, 16.5 parts by weight of deionized water, and 4.3 parts by weight of butyl glycol.

### 3.2 Production of a White Paste P2

The white paste P2 is produced from 50 parts by weight of Titanium Rutile 2310, 6 parts by weight of a polyester prepared as per example D, column 16, lines 37-59 of DE 40 09 858 A1, 24.7 parts by weight of a binder dispersion prepared as per patent application EP 022 8003 B2, page 8, lines 6 to 18, 10.5 parts by weight of deionized water, 4 parts by weight of 2,4,7,9-tetramethyl-5-decynediol, 52% in BG (available from BASF SE), 4.1 parts by weight of butyl glycol, 0.4 part by weight of 10% dimethylethanolamine in water, and 0.3 part by weight of Acrysol RM-8 (available from The Dow Chemical Company).

### 3.3 Production of a Black Paste P3

The black paste P3 is produced from 57 parts by weight of a polyurethane dispersion prepared as per WO 92/15405, page 13, line 13 to page 15, line 13, 10 parts by weight of carbon black (Monarch® 1400 carbon black from Cabot Corporation), 5 parts by weight of a polyester prepared as per example D, column 16, lines 37-59 of DE 40 09 858 A1, 6.5 parts by weight of a 10% strength aqueous dimethylethanolamine solution, 2.5 parts by weight of a commercial polyether (Pluriol® P900, available from BASF SE), 7 parts by weight of butyl diglycol, and 12 parts by weight of deionized water.

### 3.4 Production of a Barium Sulfate Paste P4

The barium sulfate paste P4 is produced from 39 parts by weight of a polyurethane dispersion prepared as per EP 0228003 B2, page 8, lines 6 to 18, 54 parts by weight of barium sulfate (Blanc fixe micro from Sachtleben Chemie GmbH), 3.7 parts by weight of butyl glycol, and 0.3 part by weight of Agitan 282 (available from Munzing Chemie GmbH) and 3 parts by weight of deionized water.

### 3.5 Production of a Steatite Paste P5

The steatite paste P5 is produced from 49.7 parts by weight of an aqueous binder dispersion prepared as per WO 91/15528, page 23, line 26 to page 24, line 24, 28.9 parts by weight of steatite (Microtalc IT extra from Mondo Minerals B.V.), 0.4 part by weight of Agitan 282 (available from Munzing Chemie GmbH), 1.45 parts by weight of Disperbyk®-184 (available from BYK-Chemie GmbH), 3.1 parts by weight of a commercial polyether (Pluriol® P900, available from BASF SE), and 16.45 parts by weight of deionized water.

### 4. Preparation of Further Intermediates

### 4.1 Preparation of a Mixing Varnish ML1

In accordance with patent specification EP 1534792 B1, column 11, lines 1-13, 81.9 parts by weight of deionized water, 2.7 parts by weight of Rheovis® AS 1130 (available from BASF SE), 8.9 parts by weight of 2,4,7,9-tetramethyl-5-decynediol, 52% in butyl glycol (available from BASF SE), 3.2 parts by weight of Dispex Ultra FA 4437 (available from BASF SE), and 3.3 parts by weight of 10% dimethylethanolamine in water are mixed with one another; the resulting mixture is subsequently homogenized.

### 4.2 Preparation of a Mixing Varnish ML2

47.38 parts by weight of the aqueous dispersion AD1, 42.29 parts by weight of deionized water, 6.05 parts by weight of 2,4,7,9-tetramethyl-5-decynediol, 52% in butyl glycol (available from BASF SE), 2.52 parts by weight of Dispex Ultra FA 4437 (available from BASF SE), 0.76 part by weight of Rheovis® AS 1130 (available from BASF SE) and 1.0 part by weight of 10% dimethylethanolamine in water are mixed with one another and the resulting mixture is subsequently homogenized.

ML1 and ML2 are used for producing effect pigment pastes.

### 5. Production of Aqueous Basecoat Materials

### 5.1 Production of Waterborne Basecoat Materials WBL1 and WBL2

The components listed under “Aqueous phase” in table 5.1 are stirred together in the order stated to form an aqueous mixture. In the next step, a premix is produced in each case from the components listed under “Aluminum pigment premix” and “Mica pigment premix”. These premixes are added separately to the aqueous mixture. Stirring takes place for 10 minutes after addition of each premix. Then deionized water and dimethylethanolamine are used to set a pH of 8 and a spray viscosity of 95±10 mPa·s under a shearing load of 1000 s⁻¹, measured using a rotational viscometer (Rheolab QC with C-LTD80/QC heating system from Anton Paar) at 23° C.

TABLE 5.1
Production of waterborne basecoat materials WBL1 and WBL2

| | WBL1 | WBL2 |
|---|---|---|
| Aqueous phase: | | |
| 3% Na Mg phyllosilicate solution | 14.4 | 13.4 |
| deionized water | 11.5 | 11.4 |
| 1-Propoxy-2-propanol | 2.4 | — |
| n-Butoxypropanol | 1.9 | 1.1 |
| 2-Ethylhexanol | 2.8 | — |
| Aqueous binder dispersion AD1 | 22.6 | — |
| Aqueous polyurethane-polyurea dispersion PD1 | 6.6 | — |
| Polyurethane dispersion prepared as per WO 92/15405, | — | 29.3 |
| page 13, line 13 to page 15, line 13 | | |
| Polyester prepared as per page 28, lines 13 to 33 | 3.8 | 1.5 |
| (example BE1) WO 2014/033135 A2 | | |
| Polyester prepared as per example D, column 16, lines | — | 2.2 |
| 37-59 of DE 40 09 858 A1 | | |
| Polyurethane-modified polyacrylate prepared as per | — | 2.2 |
| page 7, line 55 to page 8, line 23 of DE 4437535 A1 | | |
| Melamine-formaldehyde resin (Cymel ® 203 from | 2.8 | — |
| Allnex) | | |
| Melamine-formaldehyde resin (Maprenal ® 909/93IB | — | 3.3 |
| from INEOS Melamines GmbH) | | |
| 10% Dimethylethanolamine in water | 0.7 | 1.0 |
| Pluriol ® P900, available from BASF SE | 0.6 | — |
| 2,4,7,9-Tetramethyl-5-decynediol, 52% in BG | — | 0.2 |
| (available from BASF SE) | | |
| Isobutanol | 3.1 | — |
| Isopropanol | — | 1.8 |
| Butyl glycol | 1.1 | 2.6 |
| Hydrosol A170, available from DHC Solvent Chemie | — | 0.4 |
| GmbH | | |
| Methoxypropanol | — | 2.0 |
| Isopar ® L, available from Exxon Mobil | — | 1.5 |
| 50 wt % solution of Rheovis ® PU1250 in butyl | 0.3 | 0.3 |
| glycol (Rheovis ® PU1250 available from BASF SE) | | |
| BYK-347 ® from Altana/BYK-Chemie GmbH | — | 0.4 |
| Yellow paste P1 | 1.7 | 1.7 |
| White paste P2 | 0.7 | 0.7 |
| Black paste P3 | 3.4 | 3.4 |
| Barium sulfate paste P4 | 0.7 | 0.7 |
| Steatite paste P5 | 1.4 | 1.4 |
| Aluminum pigment premix: | | |
| Mixing varnish ML1 | 12.2 | 12.2 |
| Mixture of two commercial aluminum pigments, | 4.0 | 4.0 |
| available from Altana-Eckart (Stapa ® Hydrolux | | |
| 2153 & Hydrolux 600 in ratio of 1:1) | | |
| Mica pigment premix: | | |
| Mixing varnish ML1 | 1.0 | 1.0 |
| Commercial mica pigment Mearlin ® Exterior | 0.3 | 0.3 |
| Fine Russet 459V from BASF SE) | | |
| Total: | 100.0 | 100.0 |
| Pigment/binder ratio: | 0.3 | 0.3 |
| Solids content (adjusted): | 21.6% | 21.7% |

### 5.2 Production of Waterborne Basecoat Materials WBL3 to WBL6

The components listed under “Aqueous phase” in table 5.2 are stirred together in the order stated to form an aqueous mixture. In the next step, a premix is produced from the components listed under “Aluminum pigment premix”. This premix is added to the aqueous mixture. Stirring takes place for 10 minutes after the addition. Then deionized water and dimethylethanolamine are used to set a pH of 8 and a spray viscosity of 85±5 mPa·s under a shearing load of 1000 s⁻¹, measured using a rotational viscometer (Rheolab QC with C-LTD80/QC heating system from Anton Paar) at 23° C.

Within the series WBL3 to WBL4, the fraction of aluminum pigment and hence the pigment/binder ratio was lowered in each case. The same is true of the series WBL5 to WBL6.

TABLE 5.2
Production of waterborne basecoat materials WBL3 to WBL6

| | WBL3 | WBL4 | WBL5 | WBL6 |
|---|---|---|---|---|
| Aqueous phase: | | | | |
| 3% Na Mg phyllosilicate solution | 17.87 | 17.87 | 17.87 | 17.87 |
| Deionized water | 12.23 | 16.74 | 12.07 | 16.68 |
| 2-Ethylhexanol | 1.99 | 1.99 | 1.99 | 1.99 |
| Polyurethane-dispersion prepared as per | 25.41 | 25.41 | 25.41 | 25.41 |
| WO 92/15405, page 13, line 13 to page | | | | |
| 15, line 13 | | | | |
| Daotan ® VTW 6464, available from | 1.59 | 1.59 | 1.59 | 1.59 |
| Allnex | | | | |
| Polyurethane-modified polyacrylate | 2.78 | 2.78 | 2.78 | 2.78 |
| prepared as per page 7, line 55 to page | | | | |
| 8, line 23 of DE 4437535 A1 | | | | |
| 3 wt % aqueous Rheovis ® AS 1130 | 5.08 | 5.08 | 5.08 | 5.08 |
| solution, Rheovis ® AS 1130 available | | | | |
| from BASF SE | | | | |
| Melamine-formaldehyde resin (Cymel ® | 3.57 | 3.57 | 3.57 | 3.57 |
| 1133 from Allnex) | | | | |
| 10% Dimethylethanolamine in water | 0.95 | 0.95 | 0.95 | 0.95 |
| Pluriol ® P900, available from BASF SE | 0.40 | 0.40 | 0.40 | 0.40 |
| 2,4,7,9-Tetramethyl-5-decynediol, 52% in | 1.35 | 1.35 | 1.35 | 1.35 |
| BG (available from BASF SE) | | | | |
| Triisobutyl phosphate | 1.19 | 1.19 | 1.19 | 1.19 |
| Isopropanol | 1.95 | 1.95 | 1.95 | 1.95 |
| Butyl glycol | 2.54 | 2.54 | 2.54 | 2.54 |
| 50 wt % solution of Rheovis ® PU1250 in | 0.24 | 0.24 | 0.24 | 0.24 |
| butyl glycol (Rheovis ® PU1250 available | | | | |
| from BASF SE) | | | | |
| Tinuvin ® 123, available from BASF SE | 0.64 | 0.64 | 0.64 | 0.64 |
| Tinuvin ® 384-2, available from BASF SE | 0.40 | 0.40 | 0.40 | 0.40 |
| Aluminum pigment premix: | | | | |
| Aluminum pigment Stapa ® Hydrolux | 7.22 | 2.71 | — | — |
| 600, available from Altana-Eckart | | | | |
| Aluminum pigment Stapa ® Hydrolux | — | — | 7.38 | 2.77 |
| 200, available from Altana-Eckart | | | | |
| Butyl glycol | 9.60 | 9.60 | 9.60 | 9.60 |
| Polyester prepared as per example D, | 3.00 | 3.00 | 3.00 | 3.00 |
| column 16, lines 37-59 of DE 40 09 858 | | | | |
| A1 | | | | |
| Total: | 100.00 | 100.00 | 100.00 | 100.00 |
| Pigment/binder ratio: | 0.35 | 0.13 | 0.35 | 0.13 |

### 5.3 Production of Waterborne Basecoat Materials WBL7 to WBL10

The components listed under “Aqueous phase” in table 5.3 are stirred together in the order stated to form an aqueous mixture. In the next step, a premix is produced from the components listed under “Aluminum pigment premix”. This premix is added to the aqueous mixture. Stirring takes place for 10 minutes after the addition. Then deionized water and dimethylethanolamine are used to set a pH of 8 and a spray viscosity of 85±5 mPa·s under a shearing load of 1000 s⁻¹, measured using a rotational viscometer (Rheolab QC with C-LTD80/QC heating system from Anton Paar) at 23° C.

Within the series WBL7 to WBL8, the fraction of aluminum pigment and hence the pigment/binder ratio was lowered in each case. The same is true of the series WBL9 to WBL10.

TABLE 5.3
Production of waterborne basecoat materials WBL7 to WBL10

| | WBL7 | WBL8 | WBL9 | WBL10 |
|---|---|---|---|---|
| Aqueous phase: | | | | |
| 3% Na Mg phyllosilicate solution | 14.45 | 14.45 | 14.45 | 14.45 |
| Deionized water | 8.99 | 13.50 | 8.83 | 13.44 |
| 2-Ethylhexanol | 1.91 | 1.91 | 1.91 | 1.91 |
| Aqueous binder dispersion AD1 | 26.33 | 26.33 | 26.33 | 26.33 |
| Aqueous polyurethane-polyurea | 6.09 | 6.09 | 6.09 | 6.09 |
| dispersion PD1 | | | | |
| Polyester prepared as per page 28, lines | 3.01 | 3.01 | 3.01 | 3.01 |
| 13 to 33 (example BE1), | | | | |
| WO 2014/033135 A2 | | | | |
| Melamine-formaldehyde resin | 6.67 | 6.67 | 6.67 | 6.67 |
| (Cymel ® 203 from Allnex) | | | | |
| Deionized water | 1.69 | 1.69 | 1.69 | 1.69 |
| Rheovis ® AS 1130, available from BASF | 0.22 | 0.22 | 0.22 | 0.22 |
| SE | | | | |
| 10% Dimethylethanolamine in water | 0.51 | 0.51 | 0.51 | 0.51 |
| 2,4,7,9-Tetramethyl-5-decynediol, 52% in | 0.29 | 0.29 | 0.29 | 0.29 |
| BG (available from BASF SE) | | | | |
| Butyl glycol | 3.89 | 3.89 | 3.89 | 3.89 |
| 50 wt % solution of Rheovis ® PU1250 in | 0.07 | 0.07 | 0.07 | 0.07 |
| butyl glycol (Rheovis ® PU1250 available | | | | |
| from BASF SE) | | | | |
| Aluminum pigment premix: | | | | |
| Mixing varnish ML2 | 18.66 | 18.66 | 18.66 | 18.66 |
| Aluminum pigment Stapa ® Hydrolux | 7.22 | 2.71 | — | — |
| 600, available from Altana-Eckart | | | | |
| Aluminum pigment Stapa ® Hydrolux | — | — | 7.38 | 2.77 |
| 200, available from Altana-Eckart | | | | |
| Total: | 100.00 | 100.00 | 100.00 | 100.00 |
| Pigment/binder ratio: | 0.25 | 0.09 | 0.25 | 0.09 |

### 5.4 Production of Waterborne Basecoat Materials WBL17 to WBL24, WBL17a and WBL21a

The components listed under “Aqueous phase” in table 5.4 are stirred together in the order stated to form an aqueous mixture. In the next step, a premix is produced from the components listed under “Aluminum pigment premix”. This premix is added to the aqueous mixture. Stirring takes place for 10 minutes after the addition. Then deionized water and dimethylethanolamine are used to set a pH of 8 and a spray viscosity of 85±5 mPa·s under a shearing load of 1000 s⁻¹, measured using a rotational viscometer (Rheolab QC with C-LTD80/QC heating system from Anton Paar) at 23° C.

Additionally, samples WBL17 and WBL21 were adjusted to a spray viscosity of 120±5 mPa·s under a shearing load of 1000 s⁻¹, measured using a rotational viscometer (Rheolab QC with C-LTD80/QC heating system from Anton Paar) at 23° C. (resulting in WBL17a and WBL21a, respectively).

TABLE 5.4
Production of waterborne basecoat materials WBL17 to WBL24

| | WBL17 | WBL18 | WBL19 | WBL20 | WBL21 | WBL22 | WBL23 | WBL24 |
|---|---|---|---|---|---|---|---|---|
| Aqueous phase: | | | | | | | | |
| 3% Na/Mg | 17.87 | 17.87 | 17.87 | 17.87 | 17.87 | 17.87 | 17.87 | 17.87 |
| phyllosilicate solution | | | | | | | | |
| Deionized water | 11.45 | 12.07 | 16.45 | 16.68 | 11.61 | 12.07 | 16.51 | 16.68 |
| 2-ethylhexanol | 1.99 | 1.99 | 1.99 | 1.99 | 1.99 | 1.99 | 1.99 | 1.99 |
| Polyurethane dispersion | 25.41 | 25.41 | 25.41 | 25.41 | 25.41 | 25.41 | 25.41 | 25.41 |
| prepared as per WO | | | | | | | | |
| 92/15405, page 13, line | | | | | | | | |
| 13 to page 15, line 13 | | | | | | | | |
| Daotan ® VTW 6464, | 1.59 | 1.59 | 1.59 | 1.59 | 1.59 | 1.59 | 1.59 | 1.59 |
| available from Allnex | | | | | | | | |
| Polyurethane-modified | 2.78 | 2.78 | 2.78 | 2.78 | 2.78 | 2.78 | 2.78 | 2.78 |
| polyacrylate; prepared as | | | | | | | | |
| per page 7, line 55 to | | | | | | | | |
| page 8, line 23 of DE | | | | | | | | |
| 4437535 A1 | | | | | | | | |
| 3 wt % aqueous | 5.08 | 5.08 | 5.08 | 5.08 | 5.08 | 5.08 | 5.08 | 5.08 |
| Rheovis ® AS 1130 | | | | | | | | |
| solution, Rheovis ® AS | | | | | | | | |
| 1130 available from | | | | | | | | |
| BASF SE | | | | | | | | |
| Melamine-formaldehyde | 3.57 | 3.57 | 3.57 | 3.57 | 3.57 | 3.57 | 3.57 | 3.57 |
| resin (Cymel ® 1133 from | | | | | | | | |
| Allnex) | | | | | | | | |
| 10% | 0.95 | 0.95 | 0.95 | 0.95 | 0.95 | 0.95 | 0.95 | 0.95 |
| dimethylethanolamine in | | | | | | | | |
| water | | | | | | | | |
| Pluriol ® P900, available | 0.40 | 0.40 | 0.40 | 0.40 | 0.40 | 0.40 | 0.40 | 0.40 |
| from BASF SE | | | | | | | | |
| 2,4,7,9-Tetramethyl-5- | 1.35 | 1.35 | 1.35 | 1.35 | 1.35 | 1.35 | 1.35 | 1.35 |
| decynediol, 52% in BG | | | | | | | | |
| (available from BASF | | | | | | | | |
| SE) | | | | | | | | |
| Triisobutyl phosphate | 1.19 | 1.19 | 1.19 | 1.19 | 1.19 | 1.19 | 1.19 | 1.19 |
| Isopropanol | 1.95 | 1.95 | 1.95 | 1.95 | 1.95 | 1.95 | 1.95 | 1.95 |
| Butyl glycol | 2.54 | 2.54 | 2.54 | 2.54 | 2.54 | 2.54 | 2.54 | 2.54 |
| 50 wt % solution of | 0.24 | 0.24 | 0.24 | 0.24 | 0.24 | 0.24 | 0.24 | 0.24 |
| Rheovis ® PU1250 in | | | | | | | | |
| butyl glycol (Rheovis ® | | | | | | | | |
| PU1250 available from | | | | | | | | |
| BASF SE) | | | | | | | | |
| Tinuvin ® 123, available | 0.64 | 0.64 | 0.64 | 0.64 | 0.64 | 0.64 | 0.64 | 0.64 |
| from BASF SE | | | | | | | | |
| Tinuvin ® 384-2, | 0.40 | 0.40 | 0.40 | 0.40 | 0.40 | 0.40 | 0.40 | 0.40 |
| available from BASF SE | | | | | | | | |
| Aluminum pigment | | | | | | | | |
| premix: | | | | | | | | |
| Aluminum pigment | 8.00 | — | 3.00 | — | — | — | — | — |
| Stapa ® IL Hydrolan | | | | | | | | |
| 9157, available from | | | | | | | | |
| Altana-Eckart | | | | | | | | |
| Aluminum pigment | — | 7.38 | — | 2.77 | — | — | — | — |
| Stapa ® IL Hydrolan | | | | | | | | |
| 214 NO. 55, available | | | | | | | | |
| from Altana-Eckart | | | | | | | | |
| Aluminum pigment | — | — | — | — | 7.84 | — | 2.94 | — |
| Stapa ® IL Hydrolan | | | | | | | | |
| 2197, available from | | | | | | | | |
| Altana-Eckart | | | | | | | | |
| Aluminum pigment | — | — | — | — | — | 7.38 | — | 2.77 |
| Stapa ® IL Hydrolan | | | | | | | | |
| 2153, available from | | | | | | | | |
| Altana-Eckart | | | | | | | | |
| Butyl glycol | 9.60 | 9.60 | 9.60 | 9.60 | 9.60 | 9.60 | 9.60 | 9.60 |
| Polyester, prepared as | 3.00 | 3.00 | 3.00 | 3.00 | 3.00 | 3.00 | 3.00 | 3.00 |
| per example D, column | | | | | | | | |
| 16, lines 37-59 of DE 40 | | | | | | | | |
| 09 858 A1 | | | | | | | | |
| Total: | 100.00 | 100.00 | 100.00 | 100.00 | 100.00 | 100.00 | 100.00 | 100.00 |
| Pigment/binder ratio: | 0.35 | 0.13 | 0.35 | 0.13 | 0.35 | 0.13 | 0.35 | 0.13 |

### 5.5 Production of Waterborne Basecoat Materials WBL25 to WBL30

The components listed under “Aqueous phase” in table 5.5 are stirred together in the order stated to form an aqueous mixture. In the next step, a premix is produced in each case from the components listed under “Aluminum pigment premix”. These premixes are added separately to the aqueous mixture. Stirring takes place for 10 minutes after the addition of each premix. Then deionized water and dimethylethanolamine are used to set a pH of 8 and a spray viscosity of 85±10 mPa·s under a shearing load of 1000 s⁻¹, measured using a rotational viscometer (Rheolab QC with C-LTD80/QC heating system from Anton Paar) at 23° C.

TABLE 5.5
Production of waterborne basecoat materials WBL25 to WBL30

| | WBL25 | WBL26 | WBL27 | WBL28 | WBL29 | WBL30 |
|---|---|---|---|---|---|---|
| Aqueous phase: | | | | | | |
| 3% Na/Mg phyllosilicate | 14.45 | 14.45 | 14.45 | 14.45 | 14.45 | 14.45 |
| solution | | | | | | |
| Deionized water | 8.21 | 8.83 | 13.21 | 13.44 | 8.21 | 13.21 |
| 2-ethylhexanol | 1.91 | 1.91 | 1.91 | 1.91 | 1.91 | 1.91 |
| Aqueous binder | 26.33 | 26.33 | 26.33 | 26.33 | 26.33 | 26.33 |
| dispersion AD1 | | | | | | |
| Aqueous polyurethane- | 6.09 | 6.09 | 6.09 | 6.09 | 6.09 | 6.09 |
| polyurea dispersion PD1 | | | | | | |
| Polyester; prepared as | 3.01 | 3.01 | 3.01 | 3.01 | 3.01 | 3.01 |
| per page 28, lines 13 to | | | | | | |
| 33 (example BE1) WO | | | | | | |
| 2014/033135 A2 | | | | | | |
| Melamine-formaldehyde | 6.67 | 6.67 | 6.67 | 6.67 | 6.67 | 6.67 |
| resin (Cymel ® 203 from | | | | | | |
| Allnex) | | | | | | |
| Deionized water | 1.69 | 1.69 | 1.69 | 1.69 | 1.69 | 1.69 |
| Rheovis ® AS 1130, | 0.22 | 0.22 | 0.22 | 0.22 | 0.22 | 0.22 |
| available from BASF SE | | | | | | |
| 10% | 0.51 | 0.51 | 0.51 | 0.51 | 0.51 | 0.51 |
| dimethylethanolamine in | | | | | | |
| water | | | | | | |
| 2,4,7,9-tetramethyl-5- | 0.29 | 0.29 | 0.29 | 0.29 | 0.29 | 0.29 |
| decynediol, 52% in BG | | | | | | |
| (available from BASF | | | | | | |
| SE) | | | | | | |
| Butyl glycol | 3.89 | 3.89 | 3.89 | 3.89 | 3.89 | 3.89 |
| 50 wt % solution of | 0.07 | 0.07 | 0.07 | 0.07 | 0.07 | 0.07 |
| Rheovis ® PU1250 in | | | | | | |
| butyl glycol (Rheovis ® | | | | | | |
| PU1250 available from | | | | | | |
| BASF SE) | | | | | | |
| Aluminum pigment | | | | | | |
| premix: | | | | | | |
| Mixing varnish ML2 | 18.66 | 18.66 | 18.66 | 18.66 | 18.66 | 18.66 |
| Aluminum pigment | 8.00 | — | 3.00 | — | — | — |
| Stapa ® IL Hydrolan | | | | | | |
| 9157, available from | | | | | | |
| Altana-Eckart | | | | | | |
| Aluminum pigment | — | 7.38 | — | 2.77 | — | — |
| Stapa ® IL Hydrolan | | | | | | |
| 214 NO. 55, available | | | | | | |
| from Altana-Eckart | | | | | | |
| Aluminum pigment | — | — | — | — | 8.00 | 3.00 |
| Stapa ® Hydrolux | | | | | | |
| 2197, available from | | | | | | |
| Altana-Eckart | | | | | | |
| Total: | 100.00 | 100.00 | 100.00 | 100.00 | 100.00 | 100.00 |
| Pigment/binder ratio: | 0.25 | 0.09 | 0.25 | 0.09 | 0.25 | 0.09 |

### 5.6 Production of Waterborne Basecoat Materials WBL31 and WBL31a

The components listed under “Aqueous phase” in table 5.6 are stirred together in the order stated to form an aqueous mixture. In the next step, a premix is produced from the components listed under “Aluminum pigment premix”. This premix is added to the aqueous mixture. Stirring takes place for 10 minutes after the addition. Then deionized water and dimethylethanolamine are used to set a pH of 8 and a spray viscosity of 130±5 mPa·s (WBL31) or 80±5 mPa·s (WBL31a) under a shearing load of 1000 s⁻¹, measured using a rotational viscometer (Rheolab QC with C-LTD80/QC heating system from Anton Paar) at 23° C. In the case of WBL31a, this is done using a larger amount of deionized water.

TABLE 5.6
Production of waterborne basecoat materials WBL31 and WBL31a

| | WBL31 | WBL31a |
|---|---|---|
| Aqueous phase: | | |
| 3% Na-Mg phyllosilicate solution | 17.00 | 17.00 |
| Deionized water | 10.89 | 10.89 |
| 2-ethylhexanol | 1.89 | 1.89 |
| Polyurethane dispersion, prepared as per WO | 24.17 | 24.17 |
| 92/15405, page 13, line 13 to page 15, line 13 | | |
| Daotan ® VTW 6464, available from Allnex | 1.51 | 1.51 |
| Polyurethane-modified polyacrylate; prepared as per | 2.64 | 2.64 |
| page 7, line 55 to page 8, line 23 of DE 4437535 A1 | | |
| 3 wt % aqueous Rheovis ® AS 1130 solution, | 4.83 | 4.83 |
| Rheovis ® AS 1130 available from BASF SE | | |
| Melamine-formaldehyde resin (Cymel ® 1133 from | 3.40 | 3.40 |
| Allnex) | | |
| 10% dimethylethanolamine in water | 0.90 | 0.90 |
| Pluriol ® P900, available from BASF SE | 0.38 | 0.38 |
| 2,4,7,9-Tetramethyl-5-decynediol, 52% in BG | 1.28 | 1.28 |
| (available from BASF SE) | | |
| Triisobutyl phosphate | 1.13 | 1.13 |
| Isopropanol | 1.85 | 1.85 |
| Butyl glycol | 2.42 | 2.42 |
| 50 wt % solution of Rheovis ® PU1250 in butyl | 0.23 | 0.23 |
| glycol (Rheovis ® PU1250 available from | | |
| BASF SE) | | |
| Tinuvin ® 123, available from BASF SE | 0.61 | 0.61 |
| Tinuvin ® 384-2, available from BASF SE | 0.38 | 0.38 |
| Deionized water | 7.91 | 12.10 |
| Aluminum pigment premix: | | |
| Aluminum pigment Stapa ® Hydrolux | 3.26 | 3.26 |
| VP56450, available from Altana-Eckart | | |
| Aluminum pigment Stapa ® Hydrolux 1071, | 1.30 | 1.30 |
| available from Altana-Eckart | | |
| Butyl glycol | 9.21 | 9.21 |
| Polyester; prepared as per example D, | 2.79 | 2.79 |
| column 16, lines 37-59 of DE 40 09 858 A1 | | |
| Total: | 100.00 | 104.19 |
| Pigment/binder ratio: | 0.23 | 0.23 |

### 5.7 Production of Waterborne Basecoat Materials WBL32 and WBL33

The components listed under “Aqueous phase” in table 5.7 are stirred together in the order stated to form an aqueous mixture. In the next step, a premix is produced from the components listed under “Butyl glycol/polyester mixture (3:1)”. This premix is added to the aqueous mixture. Stirring takes place for 10 minutes after the addition. Then deionized water and dimethylethanolamine are used to set a pH of 8 and a spray viscosity of 135±5 mPa·s under a shearing load of 1000 s⁻¹, measured using a rotational viscometer (Rheolab QC with C-LTD80/QC heating system from Anton Paar) at 23° C.

TABLE 5.7
Production of waterborne basecoat materials WBL32 and WBL33

| | WBL32 | WBL33 |
|---|---|---|
| Aqueous phase: | | |
| 3% Na-Mg phyllosilicate solution | 20.82 | 20.82 |
| Deionized water | 13.34 | 13.34 |
| 2-ethylhexanol | 2.32 | 2.32 |
| Polyurethane dispersion, prepared as per WO | 29.60 | 29.60 |
| 92/15405, page 13, line 13 to page 15, line 13 | | |
| Daotan ® VTW 6464, available from Allnex | 1.85 | 1.85 |
| Polyurethane-modified polyacrylate; prepared as per | 3.24 | 3.24 |
| page 7, line 55 to page 8, line 23 of DE 4437535 A1 | | |
| 3 wt % aqueous Rheovis ® AS 1130 solution, | 5.92 | 5.92 |
| Rheovis ® AS 1130 available from BASF SE | | |
| Melamine-formaldehyde resin (Cymel ® 1133 from | 4.16 | 4.16 |
| Allnex) | | |
| 10% Dimethylethanolamine in water | 1.11 | 1.11 |
| Pluriol ® P900, available from BASF SE | 0.47 | 0.47 |
| 2,4,7,9-Tetramethyl-5-decynediol, 52% in BG | 1.57 | 1.57 |
| (available from BASF SE) | | |
| Triisobutyl phosphate | 1.39 | 1.39 |
| Isopropanol | 2.27 | 2.27 |
| Butyl glycol | 2.96 | 2.96 |
| 50 wt % solution of Rheovis ® PU1250 in butyl | 0.28 | 0.28 |
| glycol (Rheovis ® PU1250 available from BASF SE) | | |
| Tinuvin ® 123, available from BASF SE | 0.75 | 0.75 |
| Tinuvin ® 384-2, available from BASF SE | 0.47 | 0.47 |
| Butyl glycol/polyester mixture (3:1) | | |
| Butyl glycol | 5.63 | 9.38 |
| Polyester, prepared as per example D, column 16, | 1.88 | 3.13 |
| lines 37-59 of DE 40 09 858 A1 | | |
| Total: | 100.00 | 105.00 |

### 5.8 Production of Waterborne Basecoat Materials WBL34, WBL35, WBL34a and WBL35a

The components listed under “Aqueous phase” in table 5.8 are stirred together in the order stated to form an aqueous mixture. Following 10 minutes of stirring, deionized water and dimethylethanolamine are then used to set a pH of 8 and a spray viscosity of 120±5 mPa·s (WBL34 and WBL35) or 80±5 mPa·s (WBL34a and WBL35a) under a shearing load of 1000 s⁻¹, measured using a rotational viscometer (Rheolab QC with C-LTD80/QC heating system from Anton Parr) at 23° C.

TABLE 5.8
Production of waterborne basecoat materials
WBL34, WBL34a, WBL35 and WBL35a

| Aqueous phase: | WBL34 | WBL35 | WBL34a | WBL35a |
|---|---|---|---|---|
| 3% Na-Mg phyllosilicate solution | 19.69 | 19.69 | 19.69 | 19.69 |
| Deionized water | 12.62 | 12.62 | 12.62 | 12.62 |
| 2-ethylhexanol | 2.19 | 2.19 | 2.19 | 2.19 |
| Polyurethane dispersion, prepared | 28.00 | 28.00 | 28.00 | 28.00 |
| as per WO 92/15405, page 13, line | | | | |
| 13 to page 15, line 13 | | | | |
| Daotan ® VTW 6464, available from | 1.75 | 1.75 | 1.75 | 1.75 |
| Allnex | | | | |
| Polyurethane-modified polyacrylate; | 3.06 | 3.06 | 3.06 | 3.06 |
| prepared as per page 7, line 55 to | | | | |
| page 8, line 23 of DE 4437535 A1 | | | | |
| 3 wt % aqueous Rheovis ® AS 1130 | 5.60 | 5.60 | 5.60 | 5.60 |
| solution, Rheovis ® AS 1130 | | | | |
| available from BASF SE | | | | |
| Melamine-formaldehyde resin | 3.93 | 3.93 | 3.93 | 3.93 |
| (Cymel ® 1133 from Allnex) | | | | |
| 10% Dimethylethanolamine in water | 1.05 | 1.05 | 1.05 | 1.05 |
| Pluriol ® P900, available from BASF | 0.44 | 0.44 | 0.44 | 0.44 |
| SE | | | | |
| 2,4,7,9-Tetramethyl-5-decynediol, | 1.49 | 1.49 | 1.49 | 1.49 |
| 52% in BG (available from BASF SE) | | | | |
| Triisobutyl phosphate | 1.31 | 1.31 | 1.31 | 1.31 |
| Isopropanol | 2.15 | 2.15 | 2.15 | 2.15 |
| Butyl glycol | 2.80 | 2.80 | 2.80 | 2.80 |
| 50 wt % solution of Rheovis ® | 0.26 | 0.26 | 0.26 | 0.26 |
| PU1250 in butyl glycol (Rheovis ® | | | | |
| PU1250 available from BASF SE) | | | | |
| Tinuvin ® 123, available from BASF | 0.71 | 0.71 | 0.71 | 0.71 |
| SE | | | | |
| Tinuvin ® 384-2, available from BASF | 0.44 | 0.44 | 0.44 | 0.44 |
| SE | | | | |
| Butyl glycol | — | 12.50 | — | 12.50 |
| Deionized water | — | — | 3.00 | 3.00 |
| Total: | 87.50 | 100.00 | 90.50 | 103.00 |

6. Investigations and Comparison of the Properties of the Aqueous Basecoat Materials and of their Resultant Coatings

### 6.1 Comparison Between Waterborne Basecoat Materials WBL5 and WBL9 in the Incidence of Streakiness and the Homogeneity of the Atomization Spray

The investigations on the waterborne basecoat materials WBL5 and WBL9 (these materials each contain identical amounts of the identical aluminum pigment) with regard to streakiness and spray homogeneity take place as per the methods described above. Table 6.1 summarizes the results.

TABLE 6.1
Comparison of streakiness by homogeneity index HI (as
per patent DE 10 2009 050 075 B4) and the variables T_{T1}/T_{Total1},
T_{T2}/T_{Total2}, and the ratio thereof

| | WBL5 | WBL9 |
|---|---|---|
| T_{T1}/T_{Total1} (x = 5 mm): | 0.936 | 0.886 |
| T_{T2}/T_{Total2} (x = 25 mm): | 0.697 | 0.463 |
| T_{T1}/T_{Total1} (x = 5 mm)/T_{T2}/T_{Total2} (x = 25 mm): | 1.343 | 1.912 |
| HI(15) | 1.0 | 3.3 |
| HI(25) | 1.0 | 3.6 |
| HI(45) | 3.1 | 3.1 |
| HI(75) | 3.7 | 4.1 |
| HI(110) | 3.5 | 3.9 |
| average HI | 2.5 | 3.6 |

The numbers 15 to 110 in connection with the homogeneity index HI relate to the respective angles in ° selected when carrying out the measurement, with the respective data being determined a certain number of ° away from the specular angle. HI 15, for example, denotes that this homogeneity index pertains to the data captured at a distance of 15° from the specular angle.

WBL5 and WBL9 have identical pigmentation but differ in their basic composition.

The FIGURES in table 6.1 show that the difference in tendency to develop streakiness, which is determined by means of the homogeneity index according to patent DE 10 2009 050 075 B4, correlates with the ratio of T_{T1}/T_{Total1} at x=5 mm (inside) and T_{T2}/T_{Total2} at x=25 mm (outside):

The greater the value of the ratio formed from T_{T1}/T_{Total1} and T_{T2}/T_{Total2}, the greater the extent to which nontransparent (NT) particles, i.e., particles containing (effect) pigment, increase from inside to outside in an atomization spray. This means that during application, a material is separated more strongly into regions with different concentrations of (effect) pigments, and hence is more inhomogeneous or more susceptible to the development of streaks.

In contrast to prior-art methods such as a time-shift technique, which measures either only transparent or only nontransparent particles, the method of the invention for characterizing the atomization includes a differentiation between transparent and nontransparent particles, and combines the two pieces of information with one another. As shown by the example given above, this differentiation and combination are necessary in order to understand the processes involved in the atomization of pigmented paints.

### 6.2 Comparison Between Waterborne Basecoat Materials WBL1 and WBL2 in Terms of the Incidence of Pinholes

The investigations on waterborne basecoat materials WBL1 and WBL2 with regard to the incidence of pinholes are made according to the method described above.

Table 6.2 summarizes the results.

TABLE 6.2
Results of the investigations into incidence of pinholes
Discharge rate: 300 ml/min; Speed: 23 000 rpm

| WBL | D₁₀ [μm] | Pinholes |
|---|---|---|
| WBL1 | 32.0 | 0 |
| WBL2 | 44.3 | >100 |

By comparison with WBL1, WBL2 proved to be much more critical with regard to incidence of pinholes. This behavior correlates with a larger value of D₁₀, obtained experimentally in the case of WBL2 in comparison to WBL1 and being a measure of a coarser atomization and of an increased wetness.

6.3 Comparison Between Waterborne Basecoat Materials WBL3, WBL4, WBL6 to WBL8 and Also WBL10 with Regard to the Assessment of Cloudiness, the Incidence of Pinholes, and the Film Thickness-Dependent Leveling

The investigations on waterborne basecoat materials WBL3, WBL4, WBL6 to WBL8 and also WBL10 with regard to the assessment of cloudiness, of pinholes, and of the film thickness-dependent leveling are made in accordance with the methods described above. Tables 6.3 and 6.4 summarize the results.

TABLE 6.3
Results of the investigations into pinholes and cloudiness
(measured with the cloud-runner from Byk-Gardner)

| | D₁₀ | Discharge rate: 300 ml/min; speed: 43 000 rpm | | | |
|---|---|---|---|---|---|
| WBL | [μm] | Pinholes | Mottling15 | Mottling45 | Mottling60 |
| WBL3 | 23.5 | >100 | 3.8 | 4.2 | 4.1 |
| WBL4 | 26.8 | >100 | 2.9 | 4.4 | 3.5 |
| WBL6 | 31.5 | >100 | 4.8 | 4.4 | 6.3 |
| WBL7 | 19.1 | 0 | 3.3 | 3.9 | 3.9 |
| WBL8 | 15.9 | 0 | 2.7 | 3.8 | 3.4 |
| WBL10 | 15.6 | 0 | 4.1 | 4.4 | 6.1 |

In direct comparison of the sample pairings WBL3 and WBL7, WBL4 and WBL8, and WBL6 and WBL10, respectively, each containing the same pigment and also the same amount of pigment, it is found that at a discharge rate of 300 ml/min and a speed of 43 000 rpm, basecoat materials WBL7, WBL8, and WBL10 each have a smaller D₁₀ than the corresponding reference sample WBL3, WBL4 and WBL6 and therefore undergo finer atomization. This is reflected in a significantly better pinhole robustness and also in a lower cloudiness.

TABLE 6.4
Results of the investigations into film thickness-dependent leveling

| | | Discharge rate: 300 ml/min; Speed: 43 000 rpm | | | | | |
|---|---|---|---|---|---|---|---|
| | D₁₀ | 10-15 μm | | 15-20 μm | | 20-25 μm | |
| WBL | [μm] | SW | DOI | SW | DOI | SW | DOI |
| WBL3 | 23.5 | 11.5 | 77.3 | 16.1 | 72.2 | 17.2 | 71.6 |
| WBL5 | 30.1 | 14.7 | 64.6 | 19.9 | 63.8 | 24.0 | 60.8 |
| WBL4 | 26.8 | 8.60 | 85.05 | 11.90 | 83.82 | 14.30 | 82.73 |
| WBL6 | 31.5 | 10.40 | 74.35 | 15.10 | 71.44 | 18.70 | 68.37 |

WBL3 and WBL5 each have a pigment/binder ratio of 0.35, wherease WBL4 and WBL6 each have a pigment/binder ratio of 0.13.

The experimental results show a correlation between the D₁₀ values, and the resultant atomization properties, and the appearance/leveling, here as a function of the film thickness: on comparison of the samples with identical pigment/binder ratio of 0.35 (WBL3 and WBL5) and 0.13 (WBL4 and WBL6) it is found that a larger D₁₀ value, in other words a coarser and hence wetter atomization, leads to poorer leveling, as illustrated by the short wave and DOI figures obtained.

6.4 Comparison Between Waterborne Basecoat Materials WBL3 to WBL10 and WBL17 to WBL20 and Also WBL25 to WBL28 with Regard to Hiding Power, Clouding Propensity, Pinholes, and Leveling (Effect of Pigment)

The investigations on waterborne basecoat materials WBL3 to WBL10, WBL17 to WBL20 and also WBL25 to WBL28 with regard to hiding power, clouding propensity, pinholes, and leveling were made in accordance with the methods described above.

Illustrated specifically in this case is how the atomization and the resultant coating properties can be influenced via replacement of the aluminum pigment used, in relation in particular to its particle size. In all of the experiments the discharge rate was 300 ml/min; the rotational speed of the ESTA bell was 43 000 rpm. Tables 6.5 to 6.9 summarize the results.

TABLE 6.5
Results of the investigations into hiding power,
cloudiness (visual evaluation) and pinholes

| | Aluminum pigment | | | | | Hiding | | |
|---|---|---|---|---|---|---|---|---|
| | | Particle size | | | D₁₀ | power | | |
| WBL | Morphology | D⁵⁰⁽¹⁾ [μm] | | p/b²⁾ | [μm] | [μm] | Clouds | Pinholes |
| WBL17 | Cornflake | 19 | fine | 0.35 | 24.8 | 9 | 2-3 | 90 |
| WBL18 | Cornflake | 34 | coarse | 0.35 | 33.2 | 11 | 3-4 | 130 |
| WBL19 | Cornflake | 19 | fine | 0.13 | 29.0 | 14 | 3 | 120 |
| WBL20 | Cornflake | 34 | coarse | 0.13 | 33.3 | 16 | 3-4 | 160 |

⁽¹⁾Characteristic numbers according to technical data sheet from Eckart
²⁾p/b = pigment-binder ratio

TABLE 6.6
Results of the investigations in hiding
power, cloudiness (visual evaluation)

| | Aluminum pigment | | | | | Hiding | |
|---|---|---|---|---|---|---|---|
| | | Particle size | | | D₁₀ | power | |
| WBL | Morphology | D⁵⁰⁽¹⁾ [μm] | | p/b²⁾ | [μm] | [μm] | Clouds |
| WBL25 | Cornflake | 19 | fine | 0.25 | 19.3 | 10 | 2-3 |
| WBL26 | Cornflake | 34 | coarse | 0.25 | 17.6 | 12 | 3-4 |
| WBL27 | Cornflake | 19 | fine | 0.09 | 16.3 | 14 | 3 |
| WBL28 | Cornflake | 34 | coarse | 0.09 | 15.9 | 16 | 3-4 |

⁽¹⁾Characteristic numbers according to technical data sheet from Eckart
²⁾p/b = pigment-binder ratio

TABLE 6.7
Results of the investigations into film-thickness-dependent leveling

| | Aluminum pigment | | | | | 10-15 μm | | 15-20 μm | | 20-25 μm | |
|---|---|---|---|---|---|---|---|---|---|---|---|
| | | Particle size | | | D₁₀ | FT | | FT | | FT | |
| WBL | Morphology | D⁵⁰⁽¹⁾ [μm] | | p/b²⁾ | [μm] | SW | DOI | SW | DOI | SW | DOI |
| WBL3 | Cornflake | 16 | fine | 0.35 | 23.5 | 11.5 | 77.3 | 16.1 | 72.2 | 17.2 | 71.6 |
| WBL5 | Cornflake | 34 | coarse | 0.35 | 30.1 | 14.7 | 64.6 | 19.9 | 63.8 | 24.0 | 60.8 |
| WBL4 | Cornflake | 16 | fine | 0.13 | 26.8 | 8.6 | 85.1 | 11.9 | 83.8 | 14.3 | 82.7 |
| WBL6 | Cornflake | 34 | coarse | 0.13 | 31.5 | 10.4 | 74.3 | 15.1 | 71.4 | 18.7 | 68.4 |

⁽¹⁾Characteristic numbers according to data sheet from Eckart technical
²⁾p/b = pigment-binder ratio

TABLE 6.8
Results of the investigations into film-thickness-dependent leveling

| | Aluminum pigment | | | | | 15-20 μm | | 20-25 μm | | 25-30 μm | |
|---|---|---|---|---|---|---|---|---|---|---|---|
| | | Particle size | | | D₁₀ | FT | | FT | | FT | |
| WBL | Morphology | D⁵⁰⁽¹⁾ [μm] | | p/b²⁾ | [μm] | SW | DOI | SW | DOI | SW | DOI |
| WBL7 | Cornflake | 16 | fine | 0.25 | 19.1 | 20.6 | 70.4 | 25.1 | 62.8 | 26.1 | 62.2 |
| WBL9 | Cornflake | 34 | coarse | 0.25 | 17.2 | 23.1 | 61.9 | 25.3 | 56.6 | 26.1 | 53.6 |
| WBL8 | Cornflake | 16 | fine | 0.09 | 15.9 | 14.1 | 81.4 | 20.4 | 76.1 | 23.8 | 72.2 |
| WBL10 | Cornflake | 34 | coarse | 0.09 | 15.6 | 19.6 | 68.8 | 21.7 | 67.1 | 24.5 | 63.1 |

⁽¹⁾Characteristic numbers according to technical data sheet from Eckart
²⁾p/b = pigment-binder ratio

TABLE 6.9
Results of the investigations into cloudiness

| | Aluminum pigment | | | | | | | |
|---|---|---|---|---|---|---|---|---|
| | | Particle size | | | D₁₀ | | | |
| WBL | Morphology | D⁵⁰⁽¹⁾ [μm] | | p/b²⁾ | [μm] | Mottling15 | Mottling45 | Mottling60 |
| WBL3 | Cornflake | 16 | fine | 0.35 | 23.5 | 3.8 | 4.2 | 4.1 |
| WBL5 | Cornflake | 34 | coarse | 0.35 | 30.1 | 3.4 | 5.3 | 4.9 |
| WBL4 | Cornflake | 16 | fine | 0.13 | 26.8 | 2.9 | 4.4 | 3.5 |
| WBL6 | Cornflake | 34 | coarse | 0.13 | 31.5 | 4.8 | 4.4 | 6.3 |

⁽¹⁾Characteristic numbers according to technical data sheet from Eckart
²⁾p/b = pigment-binder ratio

In all of the cases investigated (with different pigment contents in each case), a replacement of the effect pigment used, especially in relation to its lower particle size (based on the D⁵⁰ of the pigment), results in smaller D₁₀ values. This consequently finer atomization is beneficial for the hiding power, the clouding propensity, and also pinholes and for the leveling (SW and DOI).

6.5 Comparison Between Waterborne Basecoat Materials WBL17 to WBL24 with Regard to Pinholes (Effect of the Pigment Fraction)

The investigations on waterborne basecoat materials WBL17 to WBL24 and also WBL29 and WBL30 with regard to pinholes were made in accordance with the method described above. Illustrated specifically in this case is how the atomization and the resultant coating properties can be influenced via the amount of the aluminum pigments used. In all of the experiments the discharge rate was 300 ml/min; the rotational speed of the ESTA bell was 43 000 rpm. Table 6.10 summarizes the results.

TABLE 6.10
Results of the investigations into pinholes

| | Aluminum pigment | | | | | |
|---|---|---|---|---|---|---|
| | | Particle size | | | D₁₀ | |
| WBL | Morphology | D⁵⁰⁽¹⁾ [μm] | | p/b²⁾ | [μm] | Pinholes |
| WBL17 | Cornflake | 19 | fine | 0.35 | 24.8 | 90 |
| WBL19 | Cornflake | 19 | fine | 0.13 | 29.0 | 120 |
| WBL18 | Cornflake | 34 | coarse | 0.35 | 33.2 | 130 |
| WBL20 | Cornflake | 34 | coarse | 0.13 | 33.3 | 160 |
| WBL21 | Silver dollar | 12 | fine | 0.35 | 24.0 | 90 |
| WBL22 | Silver dollar | 12 | fine | 0.13 | 28.6 | 140 |
| WBL23 | Silver dollar | 24 | coarse | 0.35 | 29.3 | 80 |
| WBL24 | Silver dollar | 24 | coarse | 0.13 | 32.4 | 100 |

⁽¹⁾Characteristic numbers according to technical data sheet from Eckart
²⁾p/b = pigment-binder ratio

In the comparison of the respective pairs of samples differing only in terms of the pigment-binder ratio, in other words in terms of the amount of pigment, it was found that an increase in the amount of the aluminum pigment used resulted in better atomization (lower D₁₀ values) and that pinholes were influenced positively as a result.

6.6 Comparison Between Waterborne Basecoat Materials WBL17 or WBL17a and Also WBL21 or WBL21a with Regard to Pinholes, Wetness, and Cloudiness (Effect of Spray Viscosity or Amount of Water)

The investigations on waterborne basecoat materials WBL17 or WBL17a and WBL21 or WBL21a and also WBL31 or WBL31a with regard to pinholes, wetness, and cloudiness were made in accordance with the methods described above. Illustrated specifically in this case is how the atomization and the resultant coating properties can be influenced via the adjusted spray viscosity (i.e. the amount of water added). In all the experiments the discharge rate was 300 ml/min; the rotational speed of the ESTA bell was 43 000 rpm. Tables 6.11 and 6.12 summarize the results.

TABLE 6.11
Results of the investigations in relation to pinholes

| | Spray viscosity | D₁₀ | |
|---|---|---|---|
| WBL | [mPa · s]¹⁾ | [μm] | Pinholes |
| WBL17 | 80 | 24.8 | 90 |
| WBL17a | 120 | 29.0 | 120 |
| WBL21 | 80 | 33.2 | 130 |
| WBL21a | 120 | 33.3 | 160 |

¹⁾Adjusted under a shearing load of 1000 s⁻¹

TABLE 6.12
Results of the investigations in relation to cloudiness and wetness

| | Spray viscosity | D(10) | | |
|---|---|---|---|---|
| WBL | [mPa · s]¹⁾ | [μm] | Wetness | Clouds |
| WBL31 | 130 | 36.2 | 4 | 4 |
| WBL31a | 80 | 24.0 | 2 | 2-3 |

¹⁾Adjusted under a shearing load of 1000 s⁻¹

The examples demonstrate that by virtue of a lower spray viscosity during the atomization of the material, finer droplets (lower D₁₀ values) are produced, with beneficial consequences for the pinhole sensitivity and also for the wetness and cloudiness of the coating system.

6.7 Comparison Between Waterborne Basecoat Materials WBL34 and WBL35 and, Respectively, WBL34a and WBL35a with Regard to Wetness

The investigations on waterborne basecoat materials WBL34 and WBL35 and, respectively, WBL34a and WBL35a with regard to wetness were made in accordance with the method described above. Illustrated specifically in this case is how the atomization and the resultant wetness, which is responsible for properties such as cloudiness, pinhole robustness, etc., can be influenced via an additional amount of a solvent. The experiments on the samples were carried out at an ESTA bell rotational speed of 43 000 rpm and 63 000 rpm. In all cases the discharge rate was 300 ml/min. Table 6.13 summarizes the results.

TABLE 6.13
Results of the investigations in relation to the degree of wetness

| | Rotational speed | Spray viscosity | D₁₀ | |
|---|---|---|---|---|
| WBL | [rpm] | [mPa · s]¹⁾ | [μm] | Wetness |
| WBL34 | 63 000 | 120 | 30.3 | 2 |
| WBL35 | 63 000 | 120 | 47.3 | 5 |
| WBL34a | 63 000 | 80 | 31.3 | 2 |
| WBL35a | 63 000 | 80 | 47.1 | 4 |
| WBL34 | 43 000 | 120 | 31.4 | 2 |
| WBL35 | 43 000 | 120 | 49.7 | 5 |
| WBL34a | 43 000 | 80 | 32.8 | 2 |
| WBL35a | 43 000 | 80 | 38.2 | 4 |

For both discharge rates (63 000 rpm and 43 000 rpm), for the respective pairs of samples adjusted to the same spray viscosity (120 mPa·s or 80 mPa·s, respectively), it was able to be shown that through the addition of butyl glycol, an effect is exerted on the D₁₀ value and hence also on the wetness, which is the cause of the sensitivity to clouding or to pinholing, for example; the solvent produces a significant increase in the D₁₀ value as a measure of the particle size during atomization, and hence produces a significantly wetter film deposited.

6.8 The examples demonstrate that by means of the method of the invention it is possible to produce coatings which, through reduction of at least one characteristic variable of the drop size distribution within the spray and/or of the homogeneity of the spray, in accordance with step (3) of the method, exhibit improved qualitative properties particularly with regard to the number of pinholes, wetness, cloudiness and/or leveling, and/or appearance and hiding power. The method of the invention is therefore a simple and efficient method for producing coatings optimized in these respects.

### 7. Investigations on Clearcoat Materials and on the Resultant Films and Coatings

Comparison Between Clearcoat Materials KL1, KL1a and KL1b with Regard to Running Limits

The investigations on clearcoat materials KL1 and KL1a and also KL1b with regard to their running behavior were made in accordance with the method described above. Illustrated specifically in this case is how the running behavior can be influenced via the spray viscosity, adapted through the addition of a solvent, and by the omission of additives known to the skilled person such as rheology control agents. The materials involved are as follows:

### Clearcoat KL1

The sample KL1 is a commercial two-component clearcoat material (ProGloss from BASF Coatings GmbH) containing fumed silica as rheological assistant (Aerosil® from Evonik), the base varnish having been adjusted using ethyl 3-ethoxypropionate to a viscosity of 100 mPa·s at 1000/s.

### Clearcoat KL1a

Sample KL1a corresponds to KL1, with the difference that the base varnish has been adjusted using ethyl 3-ethoxypropionate to a viscosity of 50 mPa·s at 1000/s.

### Clearcoat KL1b

Sample KL1b corresponds to KL1, with the difference that it contains no fumed silica as rheological assistant. The base varnish was likewise adjusted using ethyl 3-ethoxyproponiate as in the case of KL to a viscosity of 100 mPa·s at 1000/s.

The experiments were carried out on the samples at an ESTA bell rotational speed of 55 000 rpm. The discharge rate was 550 ml/min. Table 7.1 summarizes the results.

TABLE 7.1
Results of the investigations into the running behavior

| | | Start of runs | Running limit |
|---|---|---|---|
| Clearcoat | D₁₀ | (>0 mm) | (>10 mm) |
| material | [μm] | [μm] | [μm] |
| KL1 | 41.28 | 48 | 58 |
| KL1a | 41.95 | 38 | 44 |
| KL1b | 42.96 | 36 | 42 |

The results provide evidence that through receptive measures which exert an influence over the viscosity behavior, such as reducing the spray viscosity (KL1a) or eliminating the rheological assistants based on fumed silica (KL1b), in comparison to the reference KL1, the atomization is impaired (larger D₁₀ values), which is manifested in a deterioration in the running stability.

The examples demonstrate that by means of the method of the invention it is possible to produce coatings which, through reduction of the mean filament lengths in accordance with step (3) of the method, exhibit improved qualitative properties particularly with regard to the running behavior. The method of the invention is therefore a simple and efficient method for producing coatings optimized in this respect.

1. A method for producing at least one coating (B1) on a substrate, the method comprising:
(1) provision of a coating material composition (BZ1),
(2) determination of at least one characteristic variable of a drop size distribution within a spray formed on atomization of the coating material composition (BZ1) provided as per step (1), and/or of a homogeneity of this spray,
wherein the homogeneity of the spray corresponds to a ratio of two quotients T_{T1}/T_{Total1} and T_{T2}/T_{Total2} to one another as a measure of a local distribution of transparent and nontransparent drops at two different positions within the spray, with T_{T1} corresponding to a number of transparent drops at a first position 1, T_{T2} corresponding to a number of transparent drops at a second position 2, T_{Total1} corresponding to a number of all drops of the spray and hence to a sum total of transparent drops and nontransparent drops at position 1, and T_{Total2} corresponding to a number of all drops of the spray and hence to a sum total of transparent drops and nontransparent drops at position 2, with position 1 being nearer to a center of the spray than position 2,
(3) reduction of the at least one characteristic variable of the drop size distribution and/or homogeneity of the spray formed on atomization of the coating material composition (BZ1), determined as per step (2),
(4) application of at least the coating material composition (BZ1) obtained after step (3), with reduced characteristic variable of the drop size distribution and/or reduced homogeneity, to a substrate, to form at least one film (F1), and
(5) physical curing, chemical curing and/or radiation curing at least of at least one film (F1) formed on the substrate by application of the coating material composition (BZ1) as per step (4), to produce the coating (B1) on the substrate.

2. The method as claimed in claim 1, wherein the coating (B1) is part of a multicoat paint system on the substrate.

3. The method as claimed in claim 1, wherein the coating (B1) represents a basecoat of a multicoat paint system on the substrate.

4. The method as claimed in claim 1, wherein the coating material composition (BZ1) provided in step (1) comprises at least one polymer employable as binder, as component (a); at least one pigment and/or at least one filler, as component (b); and water and/or at least one organic solvent, as component (c).

5. The method as claimed in claim 1, wherein before step (5) is carried out, at least one further coating material composition (BZ2), different from the coating material composition (BZ1), is applied to the at least one film (F1) obtained as per step (4), to produce a film (F2), and the resulting films (F1) and (F2) are jointly subjected to step (5).

6. The method as claimed in claim 1, wherein the determination of the at least one characteristic variable of the drop size distribution in step (2) and the reduction of the at least one characteristic variable of the drop size distribution in step (3) entails the determination and reduction of a D₁₀ of the drops as a characteristic variable.

7. The method as claimed in claim 1, wherein the determination as per step (2) takes place by means of implementation of at least the following method steps (2a), (2b), and (2c):
(2a) atomization of the coating material composition (BZ1), provided as per step (1), by means of an atomizer, the atomization producing a spray,
(2b) optical capture of at least one drop of the spray formed by atomization as per step (2a), by a traversing optical measurement through the entire spray, and
(2c) determination of at least one characteristic variable of the drop size distribution within the spray and/or of the homogeneity of the spray, on the basis of optical data obtained by the optical capture as per step (2b).

8. The method as claimed in claim 7, wherein the optical capture as per step (2b) takes place by means of phase Doppler anemometry (PDA) and/or by means of a time-shift technique (TS).

9. The method as claimed in claim 7, wherein the optical measurement as per step (2b) takes place traversingly in a radial-axial direction in relation to a tilted atomizer used at a tilt angle of 0° to 90°.

10. The method as claimed in claim 7, wherein the at least one characteristic variable of the drop size distribution is determined as per step (2c) on the basis of optical data obtained by the optical capture as per step (2b), said data having been obtained by means of phase Doppler anemometry (PDA) and/or by means of a time-shift technique (TS), and wherein the homogeneity is determined as per step (2c) on the basis of optical data obtained by the optical capture as per step (2b), said data having been obtained by means of the time-shift technique (TS).

11. The method as claimed in claim 1, wherein the reduction of the at least one characteristic variable of the drop size distribution and/or of the homogeneity of the spray, determined as per step (2), takes place by adaptation of at least one parameter within a formula of the coating material composition (BZ1) provided as per step (1).

12. The method as claimed in claim 11, wherein the adaptation of at least one parameter within the formula of the coating material composition (BZ1) comprises at least one adaptation selected from the group consisting of adaptations of the following parameters:
(i) raising or lowering an amount of at least one polymer present as binder component (a) in the coating material composition (BZ1),
(ii) at least partially replacing at least one polymer present as binder component (a) in the coating material composition (BZ1) by at least one polymer different thereto,
(iii) raising or lowering an amount of at least one pigment and/or filler present as component (b) in the coating material composition (BZ1),
(iv) at least partially replacing at least one filler present as component (b) in the coating material composition (BZ1) by at least one filler different thereto, and/or at least partially replacing at least one pigment present as component (b) in the coating material composition (BZ1) by at least one pigment different thereto,
(v) raising or lowering an amount of at least one organic solvent present as component (c) in the coating material composition (BZ1), and/or of water present therein,
(vi) at least partially replacing at least one organic solvent present as component (c) in the coating material composition (BZ1) by at least one organic solvent different thereto,
(vii) raising or lowering an amount of at least one additive present as component (d) in the coating material composition (BZ1),
(viii) at least partially replacing at least one additive present as component (d) in the coating material composition (BZ1) by at least one additive different thereto, and/or adding at least one further additive different thereto,
(ix) changing a sequence of addition of the components used for preparing the coating material composition (BZ1), and
(x) raising or lowering an energy input of mixing when preparing the coating material composition (BZ1).

13. The method as claimed in claim 11, wherein the adaptation of at least one parameter within the formula of the coating material composition (BZ1) comprises at least one adaptation selected from the group consisting of adaptations of the following parameters:
(iii) raising or lowering an amount of at least one pigment and/or filler present as component (b) in the coating material composition (BZ1),
(iv) at least partially replacing at least one filler present as component (b) in the coating material composition (BZ1) by at least one filler different thereto, and/or at least partially replacing at least one pigment present as component (b) in the coating material composition (BZ1) by at least one pigment different thereto,
(v) raising or lowering an amount of at least one organic solvent present as component (c) in the coating material composition (BZ1), and/or of water present therein,
(vii) raising or lowering an amount of at least one additive present as component (d) in the coating material composition (BZ1), and
(viii) at least partially replacing at least one additive present as component (d) in the coating material composition (BZ1) by at least one additive different thereto, and/or adding at least one further additive different thereto.

14. The method as claimed in claim 11, wherein the adaptation of at least one parameter within the formula of the coating material composition (BZ1) comprises at least one adaptation selected from the group consisting of adaptations of the following parameters:
(iii) raising or lowering an amount of at least one pigment and/or filler present as component (b) in the coating material composition (BZ1),
(iv) at least partially replacing at least one filler present as component (b) in the coating material composition (BZ1) by at least one filler different thereto, and/or at least partially replacing at least one pigment present as component (b) in the coating material composition (BZ1) by at least one pigment different thereto, and
(v) raising or lowering an amount of at least one organic solvent present as component (c) in the coating material composition (BZ1), and/or of water present therein.

15. The method as claimed in claim 1, wherein the application as per step (4) takes place by means of atomization of the coating material composition (BZ1) obtained after step (3).

16. A coating (B1) located on a substrate, said coating being obtainable by the method as claimed in claim 1.

17. The coating (B1) as claimed in claim 16, having a smaller number of surface defects and/or optical defects relative to a coating obtainable by the method as claimed in claim 16, but without implementation of step (3).

18. The method as claimed in claim 13, wherein the
(iii) raising or lowering an amount of at least one pigment and/or filler present as component (b) in the coating material composition (BZ1) comprises raising an amount of at least one effect pigment present as component (b) in the coating material composition (BZ1).

19. The method as claimed in claim 14, wherein the
(iii) raising or lowering an amount of at least one pigment and/or filler present as component (b) in the coating material composition (BZ1) comprises raising an amount of at least one effect pigment present as component (b) in the coating material composition (BZ1).
